(19) United States
(12) Patent Application Publication
(10) Pub. No.: US 2025/0267261 A1
(43) Pub. Date: Aug. 21, 2025

(54) USING SIDE INFORMATION FOR ADAPTIVE LOOP FILTER IN VIDEO CODING

(71) Applicants: Douyin Vision Co., Ltd., Beijing (CN); Bytedance Inc., Los Angeles, CA (US)

(72) Inventors: Wenbin Yin, Beijing (CN); Kai Zhang, San Diego, CA (US); Zhipin Deng, Beijing (CN); Li Zhang, San Diego, CA (US)

(21) Appl. No.: 19/203,334

(22) Filed: May 9, 2025

Related U.S. Application Data
(63) Continuation of application No. PCT/CN2023/130993, filed on Nov. 10, 2023.

(30) Foreign Application Priority Data
Nov. 10, 2022 (WO) PCT/CN2022/131100

(51) Int. Cl. H04N 19/117; H04N 19/184; H04N 19/196; H04N 19/70

(52) U.S. Cl. CPC H04N 19/117; H04N 19/184; H04N 19/196; H04N 19/70

(57) ABSTRACT

A mechanism for processing video data is disclosed. The mechanism includes employing at least one extended tap in an adaptive loop filter (ALF) to improve an efficiency of the ALF. A conversion is performed between a visual media data and a bitstream based on the ALF.

### CROSS REFERENCE TO RELATED APPLICATIONS

This application is a continuation of International Patent Application No. PCT/CN2023/130993, filed on Nov. 10, 2023, which claims the priority to and benefits of International Patent Application No. PCT/CN2022/131100, filed on Nov. 10, 2022. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising employing an extended tap in an adaptive loop filter (ALF) to improve an efficiency of the ALF and performing a conversion between a visual media data and a bitstream based on the ALF.

Optionally, in any of the preceding aspects, another implementation of the aspect provides that the ALF comprises a spatial tap configured to utilize information of spatial neighbor samples of a target component, wherein the spatial neighbor samples neighbor a central sample to be filtered, and wherein the spatial tap is different than the at least one extended tap.

Optionally, in any of the preceding aspects, another implementation of the aspect provides that the spatial neighbor samples are reconstructed and obtained after application of a deblocking filter (DBF), a sample adaptive offset filter (SAO), a bilateral filter (BF), or combinations thereof.

Optionally, in any of the preceding aspects, another implementation of the aspect provides that the spatial tap only uses spatial neighbor luma samples to filter a central luma sample in the ALF, or wherein the spatial tap only uses spatial neighbor chroma samples to filter a central chroma sample in the ALF.

Optionally, in any of the preceding aspects, another implementation of the aspect provides that the at least one extended tap and at least one spatial tap co-exist in the ALF.

Optionally, in any of the preceding aspects, another implementation of the aspect provides that the ALF filter comprises both the at least one extended tap and at least one spatial tap.

Optionally, in any of the preceding aspects, another implementation of the aspect provides that the ALF filter comprises M extended taps and N spatial taps, where M is a positive integer, and where N is a positive integer.

Optionally, in any of the preceding aspects, another implementation of the aspect provides that the ALF is configured to use one or more input sources for one or more extended taps of the ALF.

Optionally, in any of the preceding aspects, another implementation of the aspect provides that the one or more extended taps of the ALF use one input source, and wherein the input source is based on one or more of reconstruction before a deblocking filter (DBF), an intermediate filtering result of a pre-defined filter, a reconstruction before a sample adaptive offset (SAO) or a bilateral filter (BF), prediction samples, residual samples, collocated samples, or any modification, combination, fusion, or weighted sum thereof.

Optionally, in any of the preceding aspects, another implementation of the aspect provides that the one or more extended taps of the ALF use multiple input sources, and wherein the input sources are based more than one of reconstruction before a deblocking filter (DBF), an intermediate filtering result of a pre-defined filter, a reconstruction before a sample adaptive offset (SAO) or a bilateral filter (BF), prediction samples, residual samples, collocated samples, or any modification thereof.

Optionally, in any of the preceding aspects, another implementation of the aspect provides that an input source of an extended tap is also used by other taps in the ALF, is restricted from being used by other taps in the ALF, comprises filtered residual samples, comprises a weighted sum or filtering of multiple sources, comprises an output of a function of multiple sources, or is derived based on samples in a different color component.

Optionally, in any of the preceding aspects, another implementation of the aspect provides that whether or how to apply the ALF with the at least one extended tap is based on different color formats and/or different color components.

Optionally, in any of the preceding aspects, another implementation of the aspect provides that the ALF with the at least one extended tap is only applied to process a luma component, is only applied to process a blue difference chroma component, is only applied to process a red difference chroma component, is applied to process both the blue difference chroma component and the red difference chroma component, or is applied to filter the luma component, the blue difference chroma component, and the red difference chroma component.

Optionally, in any of the preceding aspects, another implementation of the aspect provides that a coefficient of the at least one extended tap of the ALF corresponds to one or more input samples.

Optionally, in any of the preceding aspects, another implementation of the aspect provides that the coefficient only corresponds to one input sample.

Optionally, in any of the preceding aspects, another implementation of the aspect provides that the coefficient corresponds to N input samples, wherein N is a positive integer, (e.g., N=2), and wherein the N input samples are designed in a symmetrical way.

Optionally, in any of the preceding aspects, another implementation of the aspect provides that the coefficient corresponds to N input samples, wherein N is a positive integer, (e.g., N=2), and wherein the N input samples are designed in a asymmetrical way.

Optionally, in any of the preceding aspects, another implementation of the aspect provides that the coefficient is shared by multiple inputs based on geographical information, and wherein samples of the multiple inputs locate at symmetric positions.

Optionally, in any of the preceding aspects, another implementation of the aspect provides that the ALF with the at least one extended tap is configured to use shapes or sizes different from an ALF without extended taps.

Optionally, in any of the preceding aspects, another implementation of the aspect provides that the ALF filter contains different shapes for a spatial tap and the at least one extended tap, wherein a shape or a size used for one or more spatial taps is different from the shape or the size used for one or more extended taps, or wherein the shape or the size used for one or more spatial taps is identical to the shape or the size used for one or more extended taps.

Optionally, in any of the preceding aspects, another implementation of the aspect provides that a filter shape used for one or more spatial taps of the ALF filter with the at least one extended tap is diamond shape, square shape, cross shape, a symmetrical shape, an asymmetrical shape, a designed shape, determined in real-time, included in the bitstream, or derived.

Optionally, in any of the preceding aspects, another implementation of the aspect provides that a filter shape used for one or more extended taps of the ALF filter with the at least one extended tap is diamond shape, square shape, cross shape, a symmetrical shape, an asymmetrical shape, a designed shape, determined in real-time, included in the bitstream, or derived.

Optionally, in any of the preceding aspects, another implementation of the aspect provides that the ALF with the at least one extended tap includes at least one spatial tap used for filtering.

Optionally, in any of the preceding aspects, another implementation of the aspect provides that the at least one spatial tap is reconstructed prior to being input into the ALF.

Optionally, in any of the preceding aspects, another implementation of the aspect provides that a shape of the at least one spatial tap is:

Optionally, in any of the preceding aspects, another implementation of the aspect provides that a shape of the at least one spatial tap is:

Optionally, in any of the preceding aspects, another implementation of the aspect provides that one or more extended taps are applied for filtering.

Optionally, in any of the preceding aspects, another implementation of the aspect provides that the ALF filter is designed as follows:

Optionally, in any of the preceding aspects, another implementation of the aspect provides that the ALF filter is designed as follows:

Optionally, in any of the preceding aspects, another implementation of the aspect provides that the ALF filter is designed as follows:

Optionally, in any of the preceding aspects, another implementation of the aspect provides that the ALF filter is designed as follows:

Optionally, in any of the preceding aspects, another implementation of the aspect provides that geometrical-information-based transportation is applied or geometrical information is used for the ALF.

Optionally, in any of the preceding aspects, another implementation of the aspect provides that gradient information is used to generate the geometrical-information-based transportation.

Optionally, in any of the preceding aspects, another implementation of the aspect provides that the geometrical information comprises a texture direction, and wherein the texture direction is horizontal, vertical, diagonal, or distributed along with an angle of N degree, where N is 60, 120, or 150.

Optionally, in any of the preceding aspects, another implementation of the aspect provides that transportation is used for the ALF, and wherein the transportation comprises vertical flipping of coefficients or inputs, horizontal flipping of the coefficients or the inputs, an N degree of rotation of the coefficients or the inputs, where N is 90 or 135, or some combination thereof.

Optionally, in any of the preceding aspects, another implementation of the aspect provides that the geometrical-information-based transportation is applied to one or more spatial taps independently, is applied to one or more extended taps independently, or is applied to one or more spatial taps and one or more extended taps jointly.

Optionally, in any of the preceding aspects, another implementation of the aspect provides that one or more input sources are used for the at least one extended tap.

Optionally, in any of the preceding aspects, another implementation of the aspect provides that the input source A, the input source B, the input source C, the input source D, and the input source E are different, wherein the input source A, the input source B, the input source C, the input source D, and the input source E are identical, wherein an input source for the ALF is based on samples before the ALF, wherein an input source for the ALF is based on samples before the a deblocking filter (DBF), wherein an input source for the ALF is based on reconstruction samples, wherein an input source for the ALF is based on prediction samples of a current frame, wherein an input source for the ALF is based on residual samples of the current frame, or wherein an input source for the ALF is based on a coded reference picture.

Optionally, in any of the preceding aspects, another implementation of the aspect provides that an input source for the ALF is based on intermediate filtering results generated by reconstruction before the ALF and an offline-trained filter of the ALF.

Optionally, in any of the preceding aspects, another implementation of the aspect provides that a specific off-line trained filter set is applied, and wherein an offline-trained filter set indicator is included in the bitstream, pre-defined, or derived in real-time.

Optionally, in any of the preceding aspects, another implementation of the aspect provides that a specific off-line trained filter classifier is applied, and wherein an offline-trained filter classifier indicator is included in the bitstream, pre-defined, or derived in real-time.

Optionally, in any of the preceding aspects, another implementation of the aspect provides that an input source for the at least one extended tap is based on intermediate filtering results generated by reconstruction before a deblocking filter (DBF) and an offline-trained filter of the ALF.

Optionally, in any of the preceding aspects, another implementation of the aspect provides that a specific off-line trained filter set is applied, and wherein an offline-trained filter set indicator is included in the bitstream, pre-defined, or derived in real-time.

Optionally, in any of the preceding aspects, another implementation of the aspect provides that a specific off-line trained filter classifier is applied, and wherein an offline-trained filter classifier indicator is included in the bitstream, pre-defined, or derived in real-time.

Optionally, in any of the preceding aspects, another implementation of the aspect provides that an indicator for an input source is included in an adaptation parameter set (APS) of the bitstream, predefined, or derived in real-time.

Optionally, in any of the preceding aspects, another implementation of the aspect provides that a total number of extended taps inside the ALF is derived based a shape, a filter length, and a symmetrical constrain jointly.

Optionally, in any of the preceding aspects, another implementation of the aspect provides that input samples of the at least one extended tap is padded among a picture, slice, tile, or coding tree unit (CTU) boundary.

Optionally, in any of the preceding aspects, another implementation of the aspect provides that the padding is applied to any boundary during an encoding process or a decoding process, and wherein the padding is applied to a picture boundary, a sub-picture boundary, a slice boundary, a tile boundary, the CTU boundary, a coding tree block (CTB) boundary, a block boundary, a unit boundary, or a virtual boundary.

Optionally, in any of the preceding aspects, another implementation of the aspect provides that different padding methods are applied to a boundary, and wherein the different padding methods comprise extended padding, mirrored padding, duplicated padding, or motion-compensation-based padding.

Optionally, in any of the preceding aspects, another implementation of the aspect provides that samples outside a boundary are used as an input source for one or more ALF taps, and wherein the samples comprise motion-compensated padded samples outside a picture boundary, a sample that exceeds a virtual boundary, or a sample in a refreshed region of a gradual decoding refresh (GDR) area, which may or may not exceed a virtual boundary.

Optionally, in any of the preceding aspects, another implementation of the aspect provides that a first syntax element is included in the bitstream to indicate whether a filter with the at least one extended tap is enabled.

Optionally, in any of the preceding aspects, another implementation of the aspect provides that the first syntax element is coded by arithmetic coding, bypass coding, or with at least one context, and wherein the at least one context depends on coding information of a current block, a neighboring block, or a filtering shape of at least one neighboring block.

Optionally, in any of the preceding aspects, another implementation of the aspect provides that the first syntax element is binarized by unary code, truncated unary code, fixed-length code, exponential Golomb code, or truncated exponential Golomb code, wherein the first syntax element is signaled conditionally or signaled only when the extended taps are available, wherein the first syntax element is coded in a predictive way, wherein the first syntax element is predicted by an on/off decision of extended taps of at least one neighboring block, wherein the first syntax element is signaled independently for different color components, wherein the first syntax element is signaled and shared for different color components, wherein the first syntax element is signaled for a first color component but not signaled for a second color component, or wherein the first syntax element is signaled in a sequence parameter set (SPS), a picture parameter set (PPS), a picture header, a slice header, an adaptation parameter set (APS), a CTU, or a coding unit (CU).

Optionally, in any of the preceding aspects, another implementation of the aspect provides that a first syntax element is signaled to indicate which or what input sources are used for the at least one extended tap inside the ALF filter.

Optionally, in any of the preceding aspects, another implementation of the aspect provides that the first syntax element is coded by arithmetic coding, bypass coding, or with at least one context, and wherein the at least one context depends on coding information of a current block, a neighboring block, or a filtering shape of at least one neighboring block.

Optionally, in any of the preceding aspects, another implementation of the aspect provides that the first syntax element is binarized by unary code, truncated unary code, fixed-length code, exponential Golomb code, or truncated exponential Golomb code, wherein the first syntax element is signaled conditionally or signaled only when the extended taps are available, wherein the first syntax element is coded in a predictive way, wherein the first syntax element is predicted by an on/off decision of extended taps of at least one neighboring block, wherein the first syntax element is signaled independently for different color components, wherein the first syntax element is signaled and shared for different color components, wherein the first syntax element is signaled for a first color component but not signaled for a second color component, wherein the first syntax element is signaled in a sequence parameter set (SPS), a picture parameter set (PPS), a picture header, a slice header, an adaptation parameter set (APS), a CTU, or a coding unit (CU), or wherein the first syntax element is signaled in the APS for a signaled ALF filter.

Optionally, in any of the preceding aspects, another implementation of the aspect provides that one or more coefficients of the at least one extended tap inside the ALF is included in in a syntax element structure of the bitstream, and wherein the coefficients are contained in an APS, or wherein clipping parameters of extended taps or class merging results of extended taps are contained in an APS, or wherein a coefficient of an extended tap is in a predictive way, coded by arithmetic coding with at least one context, coded with bypass coding, jointly coded with the coefficient of a spatial tap, or have a predefined fixed value.

Optionally, in any of the preceding aspects, another implementation of the aspect provides using an intermediate filtering result of at least one fixed filter or adaptive filter as an input for the at least one extended tap.

Optionally, in any of the preceding aspects, another implementation of the aspect provides that the intermediate filtering result of offline-trained filter is used as input for one or more extended taps, and wherein the intermediate filtering results are generated by the reconstruction before the ALF and the offline-trained-filters of the ALF or generated by the reconstruction before a deblocking filter (DBF) and the offline-trained-filters of ALF, or wherein the intermediate filtering result of an online-trained ALF filter is used as input for one or more extended taps, or wherein the intermediate filtering results of a pre-defined filter are used as input for one or more extended taps, or wherein a gauss filter, a bilateral filter, a guided filter, a median filter, a local median filter, a non-local median filter, a filter with low-pass property may be applied, or a filter with high-pass property is applied, or wherein the intermediate filtering results of an online-trained filter is used as input for one or more extended taps, or wherein an input for intermediate filtering comprises reconstruction samples at different coding stages, and wherein the reconstruction before/after ALF of current/reference frame, the reconstruction before/after sample adaptive offset (SAO)/cross component SAO (CCSAO) of current/reference frame, the reconstruction before/after BIF of current/reference frame, the reconstruction before/after DBF of current/reference frame, or the reconstruction before/after any other stage of current/reference frame is used to generate the intermediate filtering results.

Optionally, in any of the preceding aspects, another implementation of the aspect provides using reconstruction samples before/after different coding stages of a current frame as input for the at least one extended tap.

Optionally, in any of the preceding aspects, another implementation of the aspect provides that the reconstruction before/after the deblocking filter (DBF) of a current frame is used as input for one or more extended taps, the reconstruction before/after sample adaptive offset (SAO)/cross component SAO (CCSAO) of the current frame is used as input for one or more extended taps, wherein the reconstruction before/after a bilateral filter (BIF) of current frame may be used as input for one or more extended taps, or wherein the reconstruction before/after other stages of current frame may be used as input for one or more extended taps.

Optionally, in any of the preceding aspects, another implementation of the aspect provides using the prediction/residual samples of a current frame as input for the at least one extended tap.

Optionally, in any of the preceding aspects, another implementation of the aspect provides that the prediction samples of current frame are used as input for one or more extended taps, or the residual samples of current frame are used as input for one or more extended taps.

Optionally, in any of the preceding aspects, another implementation of the aspect provides using samples inside one or more coded pictures as the input source for the at least one extended tap.

Optionally, in any of the preceding aspects, another implementation of the aspect provides that a previously coded frame comprises a reference frame in a reference picture list (RPL) or reference picture set (RPS) associated with the block/the current slice/frame, is a short-term reference picture of the block/the current slice/frame, or is long-term reference picture of the block/the current slice/frame.

Optionally, in any of the preceding aspects, another implementation of the aspect provides that the previously coded frame may not be a reference frame but is stored in the decoded picture buffer (DPB), wherein at least one indicator is signaled to indicate which previously coded frame(s) to use, wherein one indicator is signaled to indicate which reference picture list to use, wherein at least one indicator may be signaled to indicate a reference index, wherein the indicator is conditionally signaled depending on how many reference pictures are included in the RPL/RPS, or wherein the indicator may be conditionally signaled depending on how many previously decoded pictures are included in the DPB.

Optionally, in any of the preceding aspects, another implementation of the aspect provides that a determination of which frames to utilize is determined in real-time, and wherein the extended taps take information from one/multiple previously coded frames in DPB, take information from one/multiple reference frames in list 0, take information from one/multiple reference frames in list 1, take information from reference frames in both list 0 and list 1, take information from the reference frame closest to the current frame, take information from the reference frame with smallest picture order count (POC) distance to current slice/frame, take information from the reference frame with reference index equal to K (e.g., K=0) in a reference list, where K is pre-defined, derived in real-time, or included in the bitstream, take information from the collocated frame.

Optionally, in any of the preceding aspects, another implementation of the aspect provides that which frame to be utilized is determined by decoded information, defined as the top N most-frequently used reference pictures for samples within the current slice/frame, defined as the top N most-frequently used reference pictures of each reference picture list, when available, for samples within the current slice/frame, or defined as the pictures with top N smallest POC distances/absolute POC distances relative to current picture, where N is a positive integer.

Optionally, in any of the preceding aspects, another implementation of the aspect provides that whether to take information from the previously coded frames is dependent on decoded information of at least one region of the to-be-filtered block, and wherein the decoded information comprises one or more of coding modes, statistics, and characteristics.

Optionally, in any of the preceding aspects, another implementation of the aspect provides that whether to take information from the previously coded frames of at least one region of the to-be-filtered block is signaled from an encoder to a decoder, is dependent on the slice/picture type, is only applicable to inter-coded slices/pictures, is only applicable to P or B slices/pictures, is dependent on availability of reference pictures, is dependent on the reference picture information or the picture information in the DPB and, when the smallest POC distance or the smallest POC distance between reference pictures/pictures in DPB and current picture is greater than a threshold, the feature is disabled, or is dependent on the temporal layer index and/or quantization parameter (QP) and/or dimensions of the picture and applicable to blocks with a given temporal layer index or a highest temporal layer.

Optionally, in any of the preceding aspects, another implementation of the aspect provides that when the to-be-filtered block contains a portion of samples that are coded in non-inter mode, the extended taps do not use information from previously coded frames to filter the block, and wherein the non-inter mode is as intra mode or a set of coding modes that includes but is not limited to intra/IBC/Palette modes.

Optionally, in any of the preceding aspects, another implementation of the aspect provides that a distortion between a current block and a matching block is calculated and used to decide whether to take information from previously coded frames to filter current block, wherein a distortion between the collocated block in a previously coded frame and current block is used to decide whether to take information from previously coded frames to filter current block, wherein motion estimation is first used to find a matching block from at least one previously coded frame, or wherein when the distortion is larger than a pre-defined threshold, information from previously coded frames is not be used.

Optionally, in any of the preceding aspects, another implementation of the aspect provides that information contains two reference blocks and/or collocated blocks of a current block, and wherein one of the two reference blocks is from a first reference frame in list-0 and the other is from a first reference frame in list-1.

Optionally, in any of the preceding aspects, another implementation of the aspect provides that the coded reference pictures are accessed during different coding stages.

Optionally, in any of the preceding aspects, another implementation of the aspect provides that the coded reference pictures are accessed during a prediction loop stage, accessed during a loop filter stage, accessed before DBF/SAO/CCSAO/BF/ChromaBF/ALF/cross component ALF (CCALF) or any other loop-filter process, accessed during DBF/SAO/CCSAO/BF/ChromaBF/ALF/CCALF or any other loop-filter process, accessed after DBF/SAO/CCSAO/BF/ChromaBF/ALF/CCALF or any other loop-filter process, accessed after the loop filter stage, or accessed after loop filter stage by a motion compensation based padding method.

Optionally, in any of the preceding aspects, another implementation of the aspect provides that the ALF comprises more than one sub-filter.

Optionally, in any of the preceding aspects, another implementation of the aspect provides that the one sub-filter is based on samples in reference pictures, based on samples in the current picture, based on samples neighboring to the current sample, based on adjacent neighbor and/or non-adjacent neighbor samples to the current sample, based on samples collocated to the current sample, based on samples in the current picture and/or in the reference picture to the current sample, or based on at least one intermediate filtered sample generated from “another filter,” wherein the intermediate filtered sample is generated by filtering a group of samples neighboring and/or collocated to the current sample, wherein the “another filter” is pre-defined, is off-line trained, is on-line signaled, is the same location of the current sample, wherein the intermediate filtered sample is neighboring to the current sample or is adjacent, non-adjacent, or temporally collocated relative to the current sample, wherein the one sub-filter is based on reconstruction samples, based on prediction samples, based on residual samples, based on samples before deblocking, based on samples after deblocking, based on samples before DBF/SAO/CCSAO/BF, or based on samples after DBF/SAO/CCSAO/BF, wherein an ALF filter is constructed by one or more sub-filters from the following: a sub-filter calculated based on spatial neighboring reconstruction samples after SAO, based on spatial neighboring reconstruction samples before deblocking, based on spatial neighboring reconstruction samples after deblocking, based on spatial neighboring prediction samples, based on spatial neighboring residual samples, based on temporal samples in a reference picture, or based on one or more intermediate filtered sample, wherein more than one sub-filter is cascade applied or is applied without selective determination, wherein all sub-filters are cascaded applied or without selective determination, or wherein at least one sub-filter may be conditionally/adaptively used, conditioned by a syntax element, or conditioned by a pre-defined rule.

Optionally, in any of the preceding aspects, another implementation of the aspect provides that the method is implemented in post-processing or in pre-processing.

Optionally, in any of the preceding aspects, another implementation of the aspect provides that one or more of the methods are used jointly.

Optionally, in any of the preceding aspects, another implementation of the aspect provides that one or more of the methods are used individually.

Optionally, in any of the preceding aspects, another implementation of the aspect provides that the method is applied to any in-loop filtering tools, a pre-processing filtering method, or post-processing filtering method in video coding including but not limited to ALF/CCALF or any other filtering method.

Optionally, in any of the preceding aspects, another implementation of the aspect provides that the method is applied to an in-loop filtering method.

Optionally, in any of the preceding aspects, another implementation of the aspect provides that the method is applied to ALF, CCAPF, a sample adaptive offset (SAO) filter, or another in-loop filtering method.

Optionally, in any of the preceding aspects, another implementation of the aspect provides that the method is applied to a pre-processing filtering method.

Optionally, in any of the preceding aspects, another implementation of the aspect provides that the method is applied to a post-processing filtering method.

Optionally, in any of the preceding aspects, another implementation of the aspect provides that a video unit corresponding to the current ALF processing unit or the CCALF processing unit comprises one of a sequence, a picture, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), and any other region that contains more than one luma or chroma sample or pixel.

Optionally, in any of the preceding aspects, another implementation of the aspect provides that an indication of whether and/or how to apply the method is included in the bitstream.

Optionally, in any of the preceding aspects, another implementation of the aspect provides that the indication is included in the bitstream at a sequence level, at a group of pictures level, at a picture level, at a slice level, at a tile group level, in a sequence header, in a picture header, in a sequence parameter set (SPS), in a video parameter set (VPS), in a dependency parameter set (DPS), in a decoding capability information (DCI), in a picture parameter set (PPS), in an adaptation parameter set (APS), in a slice header, or in a tile group header.

Optionally, in any of the preceding aspects, another implementation of the aspect provides that the indication is included in the bitstream in a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or any other region that contains more than one sample or pixel.

Optionally, in any of the preceding aspects, another implementation of the aspect provides that whether and/or how to apply any of the methods is dependent on coded information, and wherein the coded information comprises block size, color format, a single or dual tree partitioning, a color component, a slice type, or a picture type.

Optionally, in any of the preceding aspects, another implementation of the aspect provides that the conversion includes encoding the visual media data into the bitstream.

Optionally, in any of the preceding aspects, another implementation of the aspect provides that the conversion includes decoding the visual media data from the bitstream.

A second aspect relates to an apparatus for processing media data comprising: one or more processors; and a non-transitory memory with instructions thereon, wherein the instructions upon execution by the processor cause the apparatus to perform the method of any of claims 1-92.

A third aspect relates to a non-transitory computer readable medium, comprising a computer program product for use by a video coding device, the computer program product comprising computer executable instructions stored on the non-transitory computer readable medium such that when executed by a processor cause the video coding device to perform the method of any of the disclosed embodiments.

A fourth aspect relates to a non-transitory computer-readable recording medium storing a bitstream of a video which is generated by a method performed by a video processing apparatus, wherein the method comprises the method of any of the disclosed embodiments.

A fifth aspect relates to a method for storing a bitstream of a video comprising the method of any of the disclosed embodiments.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of nominal vertical and horizontal locations of 4:2:2 luma and chroma samples in a picture.

FIG. 2 illustrates an example encoder block diagram.

FIG. 3 illustrates an example picture partitioned into raster scan slices.

FIG. 4 illustrates an example picture partitioned into rectangular scan slices.

FIG. 5 illustrates an example picture partitioned into bricks.

FIGS. 6A-6C illustrate examples of CTBs crossing picture borders.

FIG. 7 illustrates an example of intra prediction modes.

FIG. 8 illustrates an example of block boundaries in a picture.

FIG. 9 illustrates an example of pixels involved in filter usage.

FIG. 10 illustrates an example of filter shapes for ALF.

FIG. 11 illustrates an example of transformed coefficients for 5×5 diamond filter support.

FIG. 12 illustrates an example of relative coordinates for 5×5 diamond filter support.

FIG. 13 illustrates an example shape for at least one spatial tap.

FIG. 14 illustrates an example shape for at least one spatial tap.

FIG. 15 illustrates an example ALF filter with spatial and extended taps.

FIG. 16 illustrates an example ALF filter with spatial and extended taps.

FIG. 17 illustrates an example ALF filter with spatial and extended taps.

FIG. 18 illustrates an example ALF filter with spatial and extended taps.

FIG. 19 is a block diagram showing an example video processing system.

FIG. 20 is a block diagram of an example video processing apparatus.

FIG. 21 is a flowchart for an example method of video processing.

FIG. 22 is a block diagram that illustrates an example video coding system.

FIG. 23 is a block diagram that illustrates an example encoder.

FIG. 24 is a block diagram that illustrates an example decoder.

FIG. 25 is a schematic diagram of an example encoder.

FIG. 26 is a method for processing video data in accordance with an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the techniques described herein are applicable to other video codec protocols and designs.

### 1. Initial Discussion

This disclosure is related to video coding technologies. Specifically, it is related to in-loop filter and other coding tools in image/video coding. The ideas may be applied individually or in various combinations to video codecs, such as High Efficiency Video Coding (HEVC), Versatile Video Coding (VVC), or other video coding technologies.

### 2. Abbreviations

The present disclosure includes the following abbreviations. Advanced video coding (Rec. ITU-T H.264|ISO/IEC 14496-10) (AVC), coded picture buffer (CPB), clean random access (CRA), coding tree unit (CTU), coded video sequence (CVS), decoded picture buffer (DPB), decoding parameter set (DPS), general constraints information (GCI), high efficiency video coding, also known as Rec. ITU-T H.265|ISO/IEC 23008-2, (HEVC), Joint exploration model (JEM), motion constrained tile set (MCTS), network abstraction layer (NAL), output layer set (OLS), picture header (PH), picture parameter set (PPS), profile, tier, and level (PTL), picture unit (PU), reference picture resampling (RPR), raw byte sequence payload (RBSP), supplemental enhancement information (SEI), slice header (SH), sequence parameter set (SPS), video coding layer (VCL), video parameter set (VPS), versatile video coding, also known as Rec. ITU-T H.266|ISO/IEC 23090-3, (VVC), VVC test model (VTM), video usability information (VUI), transform unit (TU), coding unit (CU), deblocking filter (DF), sample adaptive offset (SAO), adaptive loop filter (ALF), coding block flag (CBF), quantization parameter (QP), rate distortion optimization (RDO), and bilateral filter (BF).

### 3. Video Coding Standards

Video coding standards have evolved primarily through the development of the ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly. Many methods have been adopted by JVET and put into the reference software named Joint Exploration Model (JEM) [2]. The JVET was renamed to be the Joint Video Experts Team (JVET) when the Versatile Video Coding (VVC) project officially started. VVC is a coding standard, targeting at 50% bitrate reduction as compared to HEVC. The VVC working draft and VVC test model (VTM) are continuously updated.

An example version of the VVC draft, i.e., Versatile Video Coding (Draft 10) may be found at: https://jvet-experts.org/doc_end_user/documents/19_Teleconference/wg11/JVET-S2001-v17.zip. An example version of the reference software of VVC, named as VTM, could be found at: https://vcgit.hhi.fraunhofer.de/jvet-u-ee2/VVCSoftware_VTM/-/tree/VTM-11.2.

International Telecommunication Union Telecommunication Standardization Sector (ITU-T) video coding experts group (VCEG) and International Organization for Standardization and the International Electrotechnical Commission (ISO/IEC) Moving Picture Experts Group (MPEG) joint technical committee (JTC) 1/subcommittee (SC) 29/working group (WG) 11 are studying the potential need for standardization of future video coding technology with a compression capability that significantly exceeds that of the current VVC standard. Such future standardization action could either take the form of extended extension(s) of VVC or an entirely new standard. The groups are working together on this exploration activity in a joint-collaboration effort known as the Joint Video Exploration Team (JVET) to evaluate compression technology designs proposed by their experts in this area. The first Exploration Experiments (EE) are established by JVET and reference software named Enhanced Compression Model (ECM) is in use. The test model ECM is updated continuously.

### 3.1 Color Space and Chroma Subsampling

Color space, also known as the color model (or color system), is a mathematical model which describes the range of colors as tuples of numbers, for example as 3 or 4 values or color components (e.g., RGB). Generally speaking, a color space is an elaboration of the coordinate system and sub-space. For video compression, the most frequently used color spaces are luma, blue difference chroma, and red difference chroma (YCbCr) and red, green, blue (RGB).

YCbCr, Y′CbCr, or YPb/CbPr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

### 3.1.1 4:4:4

In 4:4:4, each of the three Y′CbCr components have the same sample rate. Thus there is no chroma subsampling. This scheme is sometimes used in high-end film scanners and cinematic postproduction.

### 3.1.2 4:2:2

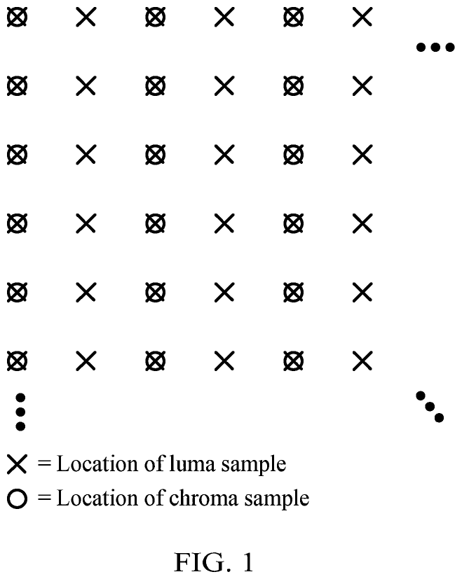

In 4:3:2, the two chroma components are sampled at half the sample rate of luma. The horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 1.

### 3.1.3 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially). In JPEG/JFIF, H.261, and MPEG-1, Cb and Cr are sited interstitially, halfway between alternate luma samples. In 4:2:0 DV, Cb and Cr are co-sited in the horizontal direction. In the vertical direction, they are co-sited on alternating lines.

TABLE 1
SubWidthC and SubHeightC values derived from chroma_{—}
format_idc and separate_colour_plane_flag

| chroma_format_idc | separate_colour_plane_flag | Chroma format | SubWidthC | SubHeightC |
|---|---|---|---|---|
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 3.2 Example Coding Flow of a Video Codec

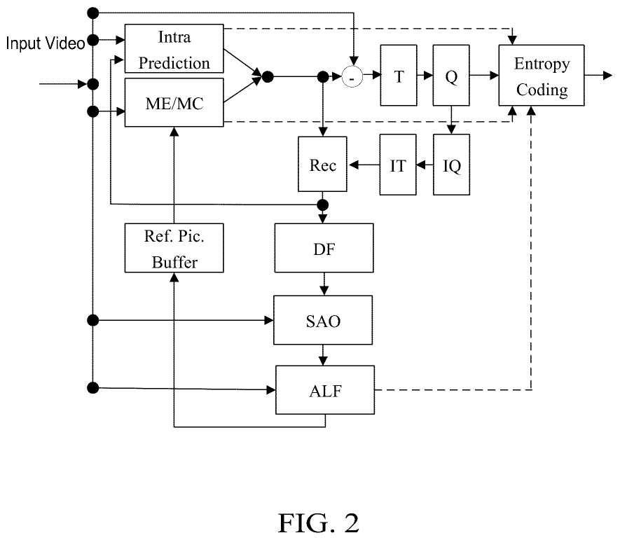

FIG. 2 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 3.3 Definitions of Video/Coding Units

A picture is divided into one or more tile rows and one or more tile columns. A tile is a sequence of CTUs that covers a rectangular region of a picture. A tile may be divided into one or more bricks, each of which includes a number of CTU rows within the tile. A tile that is not partitioned into multiple bricks may also be referred to as a brick. However, a brick that is a true subset of a tile may not be referred to as a tile. A slice either contains several tiles of a picture or several bricks of a tile.

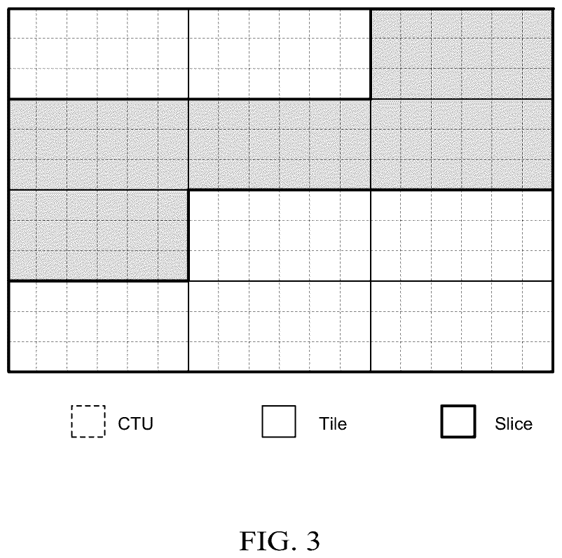

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice. FIG. 3 shows an example of raster-scan slice partitioning of a picture, where the picture is divided into 12 tiles and 3 raster-scan slices.

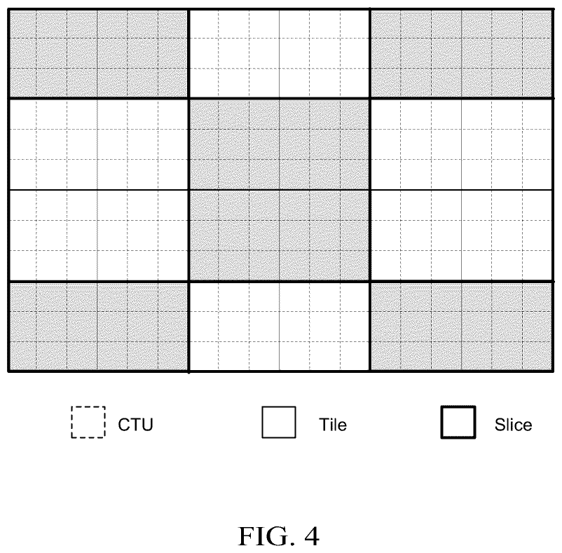

FIG. 4 shows an example of rectangular slice partitioning of a picture, where the picture is divided into 24 tiles (6 tile columns and 4 tile rows) and 9 rectangular slices.

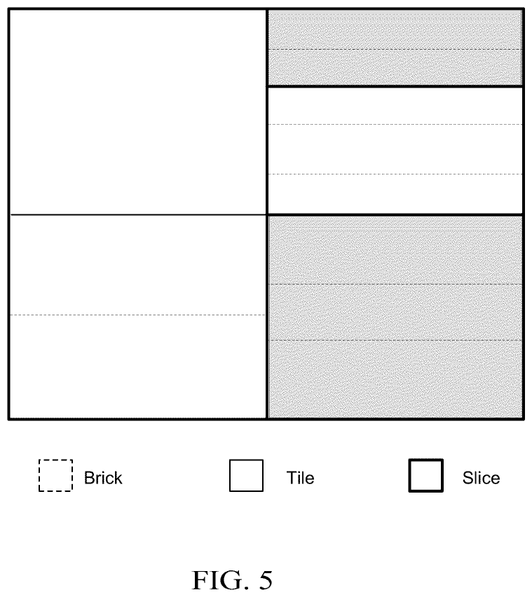

FIG. 5 shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices.

### 3.3.1 CTU/CTB Sizes

In VVC, the CTU size, signaled in a sequence parameter set (SPS) by the syntax element log2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 | |
| ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log2_ctu_size_minus2 plus 2 specifies the luma coding tree block size of each CTU. log2_min_luma_coding_block_size_minus2 plus 2 specifies the minimum luma coding block size. The variables CtbLog2SizeY, CtbSizeY, MinCbLog2SizeY, MinCbSizeY, MinTbLog2SizeY, MaxTbLog2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$Ctb Log 2 Size Y = log 2 \_ctu \_size \_minus 2 + 2 \qquad ( 7 ‐ 9 )$$

$$CtbSize Y = 1 ≪ CtbLog 2 Size Y \qquad ( 7 ‐ 10 )$$

$$MinCbLog 2 SizeY = log2\_min \_luma \_coding \_block \_size \_minus2 + 2 \qquad ( 7 ‐ 11 )$$

$$MinCbSizeY = 1 ≪ MinCbLog 2 SizeY \qquad ( 7 ‐ 12 )$$

$$MinTbLog 2 SizeY = 2 \qquad ( 7 ‐ 13 )$$

$$MaxTbLog 2 SizeY = 6 \qquad ( 7 ‐ 14 )$$

$$MinTbSizeY = 1 ≪ MinTbLog 2 SizeY \qquad ( 7 ‐ 15 )$$

$$MaxTbSizeY = 1 ≪ MaxTbLog 2 SizeY \qquad ( 7 ‐ 16 )$$

$$PicWidthlnCtbsY = Ceil ( pic\_width \_in \_luma \_samples \div CtbSizeY ) \qquad ( 7 ‐ 17 )$$

$$PicHeightlnCtbsY = Ceil ( pic\_width \_in \_luma \_samples \div CtbSizeY ) \qquad ( 7 ‐ 18 )$$

$$PicSizelnCtbsY = PicWidthlnCtbsY * PicHeightlnCtbsY \qquad ( 7 ‐ 19 )$$

$$PicWidthlnMinCbsY = pic\_width \_in \_luma \_samples / MinCbSizeY \qquad ( 7 ‐ 20 )$$

$$PicHeightnMinCbsY = pic\_height \_in \_luma \_samples / MinCbSizeY \qquad ( 7 ‐ 21 )$$

$$PicSizelnMinCbsY = PicWidthlnMinCbsY * PicHeightlnMinCbsY \qquad ( 7 ‐ 22 )$$

$$PicSizelnSamplesY = pic\_width \_in \_luma \_samples * pic\_height \_in \_luma \_samples \qquad ( 7 ‐ 23 )$$

$$PicWidthlnSamplesC = pic\_width \_in \_luma \_samples / SubWidthC \qquad ( 7 ‐ 24 )$$

$$PicHeightlnSamplesC = pic\_height \_in \_luma \_samples / SubHeightC \qquad ( 7 ‐ 25 )$$

### 3.3.2 CTUs in One Picture

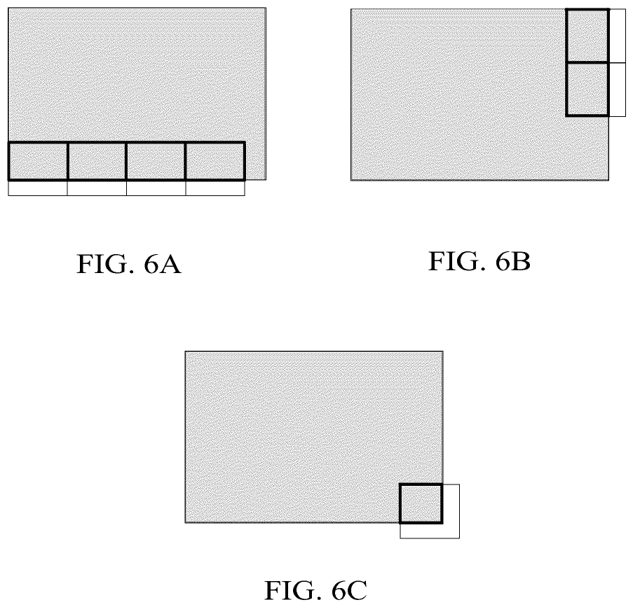

Suppose the CTB/LCU size indicated by M×N (typically M is equal to N), and for a CTB located at picture border (or tile or slice or other types of borders, picture border is taken as an example) border, K×L samples are within picture border wherein either K<M or L<N. For those CTBs as depicted in FIGS. 6A-6C, the CTB size is still equal to M×N, however, the bottom boundary/right boundary of the CTB is outside the picture.

### 3.4 Intra Prediction

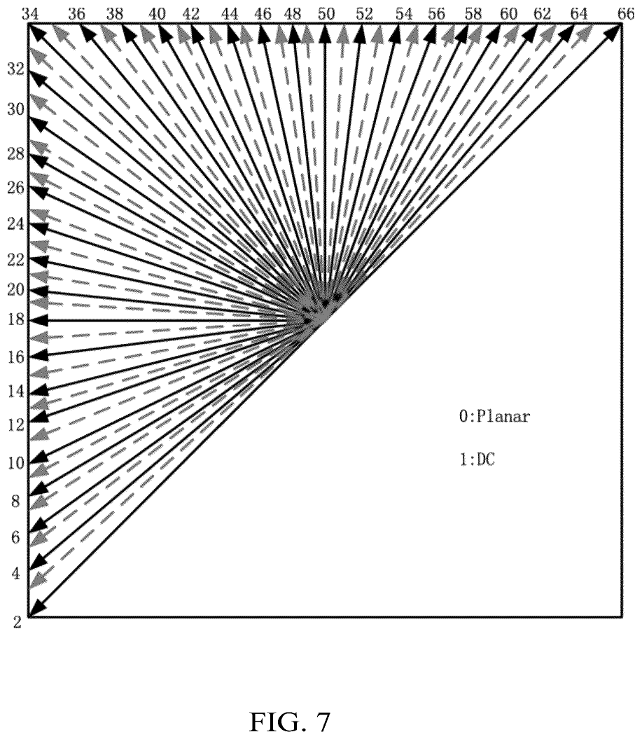

To capture the arbitrary edge directions presented in natural video, the number of directional intra modes is extended from 33, as used in HEVC, to 65. FIG. 7 illustrates an example of 67 intra prediction modes. The extended directional modes are depicted in FIG. 7, and the planar and DC modes remain the same. These denser directional intra prediction modes apply for all block sizes and for both luma and chroma intra predictions.

Angular intra prediction directions may be defined from 45 degrees to −135 degrees in clockwise direction as shown in FIG. 7. In VTM, several angular intra prediction modes are adaptively replaced with wide-angle intra prediction modes for the non-square blocks. The replaced modes are signaled and remapped to the indexes of wide angular modes after parsing. The total number of intra prediction modes is unchanged, e.g., 67, and the intra mode coding is unchanged.

In the HEVC, every intra-coded block has a square shape and the length of each of the block's sides is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 3.5 Inter Prediction

For each inter-predicted CU, motion parameters include motion vectors, reference picture indices, reference picture list usage index, and extended information used for the new coding feature of VVC to be used for inter-predicted sample generation. The motion parameters can be signaled in an explicit or implicit manner. When a CU is coded with skip mode, the CU is associated with one PU and has no significant residual coefficients, no coded motion vector delta, and/or reference picture index. A merge mode is specified whereby the motion parameters for the current CU are obtained from neighboring CUs, including spatial and temporal candidates, and extended schedules introduced in VVC. The merge mode can be applied to any inter-predicted CU, not only for skip mode. The alternative to merge mode is the explicit transmission of motion parameters, where motion vector, corresponding reference picture index for each reference picture list, reference picture list usage flag, and other useful information are signaled explicitly per each CU.

### 3.6 Deblocking Filter

Deblocking filtering is an example in-loop filter in video codec. In VVC, the deblocking filtering process is applied on CU boundaries, transform subblock boundaries, and prediction subblock boundaries. The prediction subblock boundaries include the prediction unit boundaries introduced by the Subblock based Temporal Motion Vector prediction (SbTMVP) and affine modes. The transform subblock boundaries include the transform unit boundaries introduced by Subblock transform (SBT) and Intra Sub-Partitions (ISP) modes and transforms due to implicit split of large CUs. The processing order of the deblocking filter is defined as horizontal filtering for vertical edges for the entire picture first, followed by vertical filtering for horizontal edges. This specific order enables either multiple horizontal filtering or vertical filtering processes to be applied in parallel threads. Filtering processes can also be implemented on a CTB-by-CTB basis with only a small processing latency.

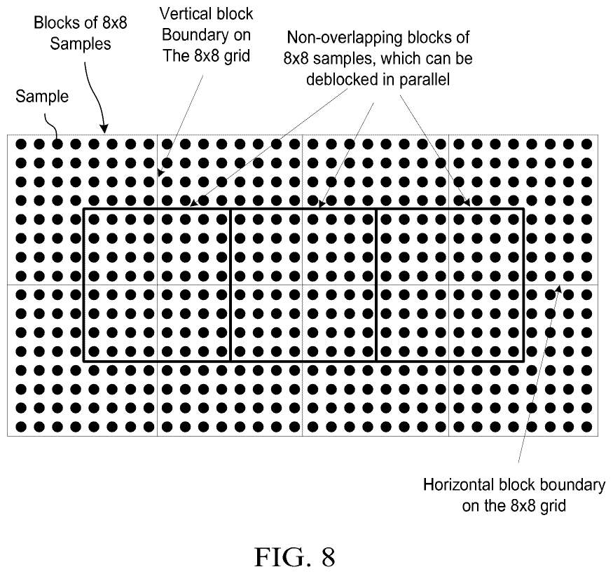

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order. FIG. 8 picture samples and horizontal and vertical block boundaries on the 8×8 grid, and the nonoverlapping blocks of the 8×8 samples, which can be deblocked in parallel.

### 3.6.1 Boundary Decision

Filtering is applied to 8×8 block boundaries. In addition, such boundaries must be a transform block boundary or a coding subblock boundary, for example due to usage of Affine motion prediction (ATMVP). For other boundaries, deblocking filtering is disabled.

### 3.6.2 Boundary Strength Calculation

For a transform block boundary/coding subblock boundary, if the boundary is located in the 8×8 grid, the boundary may be filtered and the setting of bS[xDi][yDj] (wherein [xDi][yDj] denotes the coordinate) for this edge as defined in Table 2 and Table 3, respectively.

TABLE 2
Boundary strength (when SPS IB C is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks has non-zero | 1 | 1 | 1 |
| | transform coefficients | | | |
| 3 | Reference pictures or number of MVs (1 for uni-prediction, 2 for bi- | 1 | N/A | N/A |
| | prediction) of the adjacent blocks are different | | | |
| 2 | Absolute difference between the motion vectors of same reference picture | 1 | N/A | N/A |
| | that belong to the adjacent blocks is greater than or equal to one integer | | | |
| | luma sample | | | |
| | Otherwise | 0 | 0 | 0 |

TABLE 3
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent blocks has non-zero | 1 | 1 | 1 |
| | transform coefficients | | | |
| 6 | Prediction mode of adjacent blocks is different (e.g., one is IBC, one is | 1 | | |
| | inter) | | | |
| 5 | Both IBC and absolute difference between the motion vectors that belong | 1 | N/A | N/A |
| | to the adjacent blocks is greater than or equal to one integer luma sample | | | |
| 4 | Reference pictures or number of MVs (1 for uni-prediction, 2 for bi- | 1 | N/A | N/A |
| | prediction) of the adjacent blocks are different | | | |
| 3 | Absolute difference between the motion vectors of same reference picture | 1 | N/A | N/A |
| | that belong to the adjacent blocks is greater than or equal to one integer | | | |
| | luma sample | | | |
| 1 | Otherwise | 0 | 0 | 0 |

### 3.6.3 Deblocking Decision for Luma Component

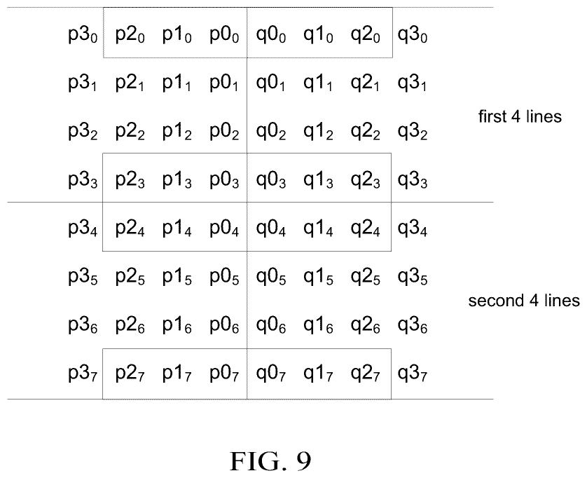

FIG. 9 illustrates pixels involved in filter on/off decision and strong/weak filter selection. Wider-stronger luma filter is filters are used only if all the Condition 1, Condition 2 and Condition 3 are TRUE. The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.
bSidePisLargeBlk=((edge type is vertical and p₀ belongs to CU with width>=32)∥(edge type is horizontal and p₀ belongs to CU with height>=32))? TRUE:FALSE
bSideQisLargeBlk=((edge type is vertical and q₀ belongs to CU with width>=32)∥(edge type is horizontal and q₀ belongs to CU with height>=32))? TRUE:FALSE

Based on bSidePisLargeBlk and bSideQisLargeBlk, the condition 1 is defined as follows:

Condition1=(bSidePisLargeBlk∥bSidePisLargeBlk)? TRUE:FALSE

Next, if Condition 1 is true, the condition 2 will be further checked. First, the following variables are derived:
dp0, dp3, dq0, dq3 are first derived as in HEVC
if (p side is greater than or equal to 32)

$$\begin{matrix}dp 0 = ( dp 0 + Abs ( p 50 - 2 * p 40 + p 30 ) + 1 ) ≫ 1 \\ dp 3 = ( dp 3 + Abs ( p 53 - 2 * p 43 + p 33 ) + 1 ) ≫ 1\end{matrix}$$

if (q side is greater than or equal to 32)

$$\begin{matrix}dq 0 = ( dq 0 + Abs ( q 50 - 2 * q 40 + q 30 ) + 1 ) ≫ 1 \\ dq 3 = ( dq 3 + Abs ( q 53 - 2 * q 43 + q 33 ) + 1 ) ≫ 1\end{matrix}$$

Condition2=(d<β)? TRUE:FALSE

$$where d = dp 0 + dq 0 + dp 3 + dq 3.$$

If Condition1 and Condition2 are valid, whether any of the blocks uses sub-blocks is further checked:

```
If (bSidePisLargeBlk)
  {
    If (mode block P == SUBBLOCKMODE)
      Sp =5
      else
      Sp =7
}
else
  Sp = 3
If (bSideQisLargeBlk)
  {
    If (mode block Q == SUBBLOCKMODE)
        Sq =5
      else
        Sq =7
    }
else
  Sq = 3
```

Finally, if both the Condition 1 and Condition 2 are valid, the deblocking method will check the condition 3 (the large block strong filter condition), which is defined as follows. In the Condition3 StrongFilterCondition, the following variables are derived:
dpq is derived as in HEVC.
sp3=Abs(p3−p0), derived as in HEVC
if (p side is greater than or equal to 32)
   if (Sp==5)

$$sp 3 = ( sp 3 + Abs ( p 5 - p 3 ) + 1 ) ≫ 1$$

else

$$sp 3 = ( sp 3 + Abs ( p 7 - p 3 ) + 1 ) ≫ 1$$

sq3=Abs(q0−q3), derived as in HEVC
if (q side is greater than or equal to 32)
   If (Sq==5)

$$sq 3 = ( s q 3 + Abs ( q 5 - q 3 ) + 1 ) ≫ 1$$

else

$$sq 3 = ( sq 3 + Abs ( q 7 - q 3 ) + 1 ) ≫ 1$$

As in HEVC, StrongFilterCondition=(dpq is less than (β>>2), sp3+sq3 is less than (3*β>>5), and Abs(p0−q0) is less than (5*tC+1)>>1)? TRUE:FALSE.

### 3.6.4 Stronger Deblocking Filter for Luma

Bilinear filter is used when samples at either one side of a boundary belong to a large block. A sample belonging to a large block is defined as when the width>=32 for a vertical edge, and when height>=32 for a horizontal edge. The bilinear filter is listed below. Block boundary samples pi for i=0 to Sp−1 and qi for j=0 to Sq−1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${q}_{i}^{′} = ( {g}_{i} * {Middle}_{s , t} + ( 64 - {g}_{i} ) * {Q}_{s} + 32 ) ≫ 6 ) , clipped to {q}_{i} \pm {tcPD}_{j}$$

where tcPDᵢ and tcPDⱼ term is a position dependent clipping described above and gⱼ, fᵢ, Middle_{s,t}, Pₛ and Qₛ are given below:

### 3.6.5 Deblocking Decision for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped. Chroma deblocking is performed when bS is equal to 2, or bS is equal to 1 when a large block boundary is detected. The second and third condition is basically the same as HEVC luma strong filter decision as follows.

In the second condition d is then derived as in HEVC luma deblocking. The second condition will be TRUE when d is less than β. In the third condition StrongFilterCondition is derived as follows:
dpq is derived as in HEVC.
sp₃=Abs(p₃−p₀), derived as in HEVC
sq₃=Abs(q₁−q₃), derived as in HEVC

As in HEVC design, StrongFilterCondition=(dpq is less than (β>>2), sp3+sq3 is less than (β>>3), and Abs(p0−q0) is less than (5*tC+1)>>1)

### 3.6.6 Strong Deblocking Filter for Chroma

The following strong deblocking filter for chroma is defined:

$$p {2}^{′} = ( 3 * p 3 + 2 * p 2 + p 1 + p 0 + q 0 + 4 ) ≫ 3$$

$$p {1}^{′} = ( 2 * p 3 + p 2 + 2 * p 1 + p 0 + q 0 + q 1 + 4 ) ≫ 3$$

$$p {0}^{′} = ( p 3 + p 2 + p 1 + 2 * p 0 + q 0 + q 1 + q 2 + 4 ) ≫ 3$$

An example chroma filter performs deblocking on a 4×4 chroma sample grid.

### 3.6.7 Position Dependent Clipping

The position dependent clipping tcPD is applied to the output samples of the luma filtering process involving strong and long filters that are modifying 7, 5 and 3 samples at the boundary. Assuming quantization error distribution, a clipping value may be increased for samples which are expected to have higher quantization noise, thus expected to have higher deviation of the reconstructed sample value from the true sample value.

For each P or Q boundary filtered with asymmetrical filter, depending on the result of decision-making process, position dependent threshold table is selected from two tables (e.g., Tc7 and Tc3 tabulated below) that are provided to decoder as a side information:
Tc7={6, 5, 4, 3, 2, 1, 1}; Tc3={6, 4, 2};
tcPD=(Sp==3)? Tc3:Tc7;
tcQD=(Sq==3)? Tc3:Tc7;

For the P or Q boundaries being filtered with a short symmetrical filter, position dependent threshold of lower magnitude is applied:
Tc3={3, 2, 1};

Following defining the threshold, filtered p′i and q′i sample values are clipped according to tcP and tcQ clipping values:

$${p}^{″} i = Clip 3 ( {p}^{′} i + tcPi , {p}^{′} i - tcPi , {p}^{′} i ) ;$$

$${q}^{″} j = Clip 3 ( {q}^{′} j + tcQj , {q}^{′} i - tcQ j , {q}^{′} i ) ;$$

where p′i and q′i are filtered sample values, p″i and q″j are output sample value after the clipping and tcPi tcPi are clipping thresholds that are derived from the VVC tc parameter and tcPD and tcQD. The function Clip3 is a clipping function as it is specified in VVC.

### 3.6.8 Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Extendedly, the sub-block deblocking is adjusted such that that sub-block boundaries on an 8×8 grid that are close to a CU or an implicit TU boundary is restricted to modify at most two samples on each side.

The following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 || edge == (orthogonalLength − 2) || edge == (56 / 4) || edge == (72 / 4))
        Sp = Sq = 2;
      else
        Sp = Sq = 3;
  else
      Sp = Sq = bSideQisLargeBlk ? 5:3
}
```

where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 3.7 Sample Adaptive Offset

Sample adaptive offset (SAO) is applied to the reconstructed signal after the deblocking filter by using offsets specified for each CTB by the encoder. The video encoder first makes the decision on whether or not the SAO process is to be applied for current slice. If SAO is applied for the slice, each CTB is classified as one of five SAO types as shown in Table 4. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up_flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above.

TABLE 4
Specification of SA O type

| SA O | | Number of |
|---|---|---|
| type | sample adaptive offset type to be used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

### 3.8 Adaptive Loop Filter

Adaptive loop filtering for video coding is to minimize the mean square error between original samples and decoded samples by using Wiener-based adaptive filter. The ALF is located at the last processing stage for each picture and can be regarded as a tool to catch and fix artifacts from previous stages. The suitable filter coefficients are determined by the encoder and explicitly signaled to the decoder. To achieve better coding efficiency, especially for high resolution videos, local adaptation is used for luma signals by applying different filters to different regions or blocks in a picture. In addition to filter adaptation, filter on/off control at coding tree unit (CTU) level is also helpful for improving coding efficiency. Syntax-wise, filter coefficients are sent in a picture level header called adaptation parameter set, and filter on/off flags of CTUs are interleaved at CTU level in the slice data. This syntax design not only supports picture level optimization but also achieves a low encoding latency.

### 3.8.1 Signaling of Parameters

According to ALF design in VTM, filter coefficients and clipping indices are carried in ALF APSs. An ALF APS can include up to 8 chroma filters and one luma filter set with up to 25 filters. An index is also included for each of the 25 luma classes. Classes having the same index share the same filter. By merging different classes, the num of bits required to represent the filter coefficients is reduced. The absolute value of a filter coefficient is represented using a 0th order Exp-Golomb code followed by a sign bit for a non-zero coefficient. When clipping is enabled, a clipping index is also signaled for each filter coefficient using a two-bit fixed-length code. Up to 8 ALF APSs can be used by the decoder at the same time.

Filter control syntax elements of ALF in VTM include two types of information. First, ALF on/off flags are signaled at sequence, picture, slice and CTB levels. Chroma ALF can be enabled at picture and slice level only if luma ALF is enabled at the corresponding level. Second, filter usage information is signaled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signaled indicating which ALF APS or offline trained luma filter set is used. For a chroma CTB, the index indicates which filter in the referenced APS is used.

The data syntax elements of ALF associated to LUMA component in VTM are listed as follows:

| | Descriptor |
|---|---|
| alf_data( ) { | |
| alf_luma_filter_signal_flag | u(1) |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtldx < NumA IfFilters; filtIdx++ ) | |
| alf_luma coeff_delta_Idx[ filtldx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j=0; ] < 12; j++ ) | |
| alf_luma_clip_Idx[ sfIdx ][ j ] | u(2) |
| } | |

alf_luma_filter_signal_flag equal to 1 specifies that a luma filter set is signaled. alf_luma_filter_signal_flag equal to 0 specifies that a luma filter set is not signaled. alf_luma_clip_flag equal to 0 specifies that linear adaptive loop filtering is applied to the luma component. alf_luma_clip_flag equal to 1 specifies that non-linear adaptive loop filtering could be applied to the luma component alf_luma_num_filters_signaled_minus1 plus 1 specifies the number of adpative loop filter classes for which luma coefficients can be signaled. The value of alf_luma_num_filters_signaled_minus1 shall be in the range of 0 to NumAlfFilters−1, inclusive. alf_luma_coeff_delta_idx[filtIdx] specifies the indices of the signaled adaptive loop filter luma coefficient deltas for the filter class indicated by filtIdx ranging from 0 to NumAlfFilters−1. When alf_luma_coeff_delta_idx[filtIdx] is not present, it is inferred to be equal to 0. The length of alf_luma_coeff_delta_idx[filtIdx] is Ceil(Log2(alf_luma_num_filters_signaled_minus1+1)) bits. The value of alf_luma_coeff_delta_idx[filtIdx] shall be in the range of 0 to alf_luma_num_filters_signaled_minus1, inclusive.

alf_luma_coeff_abs[sfIdx][j] specifies the absolute value of the j-th coefficient of the signaled luma filter indicated by sfIdx. When alf_luma_coeff_abs[sfIdx][j] is not present, it is inferred to be equal 0. The value of alf_luma_coeff_abs[sfIdx][j] shall be in the range of 0 to 128, inclusive. alf_luma_coeff_sign[sfIdx][j] specifies the sign of the j-th luma coefficient of the filter indicated by sfIdx as follows:
If alf_luma_coeff_sign[sfIdx][j] is equal to 0, the corresponding luma filter coefficient has a positive value.
Otherwise (alf_luma_coeff_sign[sfIdx][j] is equal to 1), the corresponding luma filter coefficient has a negative value.
   When alf_luma_coeff_sign[sfIdx][j] is not present, it is inferred to be equal to 0.

alf_luma_clip_idx[sfIdx][j] specifies the clipping index of the clipping value to use before multiplying by the j-th coefficient of the signaled luma filter indicated by sfIdx. When alf_luma_clip_idx[sfIdx][j] is not present, it is inferred to be equal to 0. The coding tree unit syntax elements of ALF associated to LUMA component in VTM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma prev_filter_idx | ae(v) |
| } else | |
| alf_luma_fixed_filter_idx | ae(v) |
| } | |
| } | |

alf_ctb_flag[cIdx][xCtb>>CtbLog2SizeY][yCtb>>CtbLog2SizeY] equal to 1 specifies that the adaptive loop filter is applied to the coding tree block of the colour component indicated by cIdx of the coding tree unit at luma location (xCtb, yCtb). alf_ctb_flag[cIdx][xCtb>>CtbLog2SizeY][yCtb>>CtbLog2SizeY] equal to 0 specifies that the adaptive loop filter is not applied to the coding tree block of the colour component indicated by cIdx of the coding tree unit at luma location (xCtb, yCtb).

When alf_ctb_flag[cIdx][xCtb>>CtbLog2SizeY][yCtb>>CtbLog2SizeY] is not present, it is inferred to be equal to 0. alf_use_aps_flag equal to 0 specifies that one of the fixed filter sets is applied to the luma CTB. alf_use_aps_flag equal to 1 specifies that a filter set from an APS is applied to the luma CTB. When alf_use_aps_flag is not present, it is inferred to be equal to 0. alf_luma_prev_filter_idx specifies the previous filter that is applied to the luma CTB. The value of alf_luma_prev_filter_idx shall be in a range of 0 to sh_num_alf_aps_ids_luma−1, inclusive. When alf_luma_prev_filter_idx is not present, it is inferred to be equal to 0.

The variable AlfCtbFiltSetIdxY[xCtb>>CtbLog2SizeY][yCtb>>CtbLog2SizeY] specifying the filter set index for the luma CTB at location (xCtb, yCtb) is derived as follows:
If alf_use_aps_flag is equal to 0, AlfCtbFiltSetIdxY[xCtb>>CtbLog2SizeY][yCtb>>CtbLog2SizeY] is set equal to alf_luma_fixed_filter_idx.
Otherwise, AlfCtbFiltSetIdxY[xCtb>>CtbLog2SizeY][yCtb>>CtbLog2SizeY] is set equal to 16+alf_luma_prev_filter_idx.

alf_luma_fixed_filter_idx specifies the fixed filter that is applied to the luma CTB. The value of alf_luma_fixed_filter_idx shall be in a range of 0 to 15, inclusive.

Based on the ALF design of VTM, the ALF design of ECM further introduces the concept of alternative filter sets into luma filters. The luma filters are be trained multiple alternatives/rounds based on the updated luma CTU ALF on/off decisions of each alternative/rounds. In such way, there will be multiple filter sets that associated to each training alternative and the class merging results of each filter set may be different. Each CTU could select the best filter set by RDO and the related alternative information will be signaled. The data syntax elements of ALF associated to LUMA component in ECM are listed as follows:

| | Descriptor |
|---|---|
| alf_data( ) { | |
| alf_luma_filter_signal_flag | u(1) |
| if( alf_luma_filter_signal_flag ) { | |
| alf_luma_num_alts_minus1 | ue(v) |
| for(altIdx = 0; altIdx < alf_luma_num_alts_minus1 +1; altl dx++) { | |
| alf_luma clip_flag[altIdx] | u(1) |
| alf_luma num_filters_signalled_minus1[altIdx] | ue(v) |
| if(alf_luma_num_filters_signalled_minus1[altIdx] > 0) { | |
| for( filtIdx = 0; filtIdx < NumA IfFilters; filtIdx++ ) | |
| alf_luma_coeff_delta_Idx[altIdx][filtldx] | u(v) |
| } | |
| for(sfIdx = 0; sfIdx <= alf_luma_num_filters_signalled_minus1[altIdx]; | |
| sfIdx++){ | |
| for(j = 0; j < 19; j++) { | |
| alf_luma_coeff_abs[altIdx][ sfIdx ][ j ] | ue(v) |
| if( alf_luma_coeff_abs[altIdx][ sfIdx ][ j ] ) | |
| alf luma_coeff_sign[altIdx][ sfIdx ][ j ] | u(1) |
| } | |
| } | |
| if( alf_luma_clip_flag [altIdx]) | |
| for( sfIdx = 0; sfIdx <= alf_luma_num_filters_signalled_minus1[altIdx]; | |
| sfIdx++ ) | |
| for( j = 0; j <19; j++ ) | |
| alf_luma_clip_Idx[altIdx][ sfIdx ][ j ] | u(2) |
| } | |
| } | |

alf_luma_num_alts_minus1 plus 1 specifies the number of alternative filter sets for luma component. The value of alf_luma_num_alts_minus1 shall be in the range of 0 to 3, inclusive. alf_luma_clip_flag[altIdx] equal to 0 specifies that linear adaptive loop filtering is applied to the alternative luma filter set with index altIdxluma component. alf_luma_clip_flag[altIdx] equal to 1 specifies that non-linear adaptive loop filtering could be applied to the alternative luma filter set with index altIdx luma component. alf_luma_num_filters_signaled_minus1[altIdx] plus 1 specifies the number of adpative loop filter classes for which luma coefficients can be signaled of the alternative luma filter set with index altIdx. The value of alf_luma_num_filters_signaled_minus1[altIdx] shall be in the range of 0 to NumAlfFilters−1, inclusive.

alf_luma_coeff_delta_idx[altIdx][filtIdx] specifies the indices of the signaled adaptive loop filter luma coefficient deltas for the filter class indicated by filtIdx ranging from 0 to NumAlfFilters−1 for the alternative luma filter set with index altIdx. When alf_luma_coeff_delta_idx[filtIdx][altIdx] is not present, it is inferred to be equal to 0 The length of alf_luma_coeff_delta_idx[altIdx][filtIdx] is Ceil(Log2(alf_luma_num_filters_signaled_minus1[altIdx]+1)) bits. The value of alf_luma_coeff_delta_idx[altIdx][filtIdx] shall be in the range of 0 to alf_luma_num_filters_signaled_minus1[altIdx], inclusive. alf_luma_coeff_abs[altIdx][sfIdx][j] specifies the absolute value of the j-th coefficient of the signaled luma filter indicated by sfIdx of the alternative luma filter set with index altIdx. When alf_luma_coeff_abs[altIdx][sfIdx][j] is not present, it is inferred to be equal 0. The value of alf_luma_coeff_abs[altIdx][sfIdx][j] shall be in the range of 0 to 128, inclusive.

alf_luma_coeff_sign[altIdx][sfIdx][j] specifies the sign of the j-th luma coefficient of the filter indicated by sfIdx of the alternative luma filter set with index altIdx as follows:
If alf_luma_coeff_sign[altIdx][sfIdx][j] is equal to 0, the corresponding luma filter coefficient has a positive value.
Otherwise (alf_luma_coeff_sign[altIdx][sfIdx][j] is equal to 1), the corresponding luma filter coefficient has a negative value.
   When alf_luma_coeff_sign[altIdx][sfIdx][j] is not present, it is inferred to be equal to 0.

alf_luma_clip_idx[altIdx][sfIdx][j] specifies the clipping index of the clipping value to use before multiplying by the j-th coefficient of the signaled luma filter indicated by sfIdx of the alternative luma filter set with index altIdx. When alf_luma_clip_idx[altIdx][sfIdx][j] is not present, it is inferred to be equal to 0. The coding tree unit syntax elements of ALF associated to LUMA component in ECM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alt_ctb_luma_filter_alt_idx[CtbA ddrX ][ CtbA ddrY ] | ae(v) |
| alf_luma_prev_filter_idx | ae(v) |
| } else | |
| alf_luma_fixed_filter_idx | ae(v) |
| } | |
| } | |

alf_ctb_luma_filter_alt_idx[xCtb>>CtbLog2SizeY][yCtb>>CtbLog2SizeY] specifies the index of the alternative luma filters applied to the coding tree block of the luma component, of the coding tree unit at luma location (xCtb, yCtb). When alf_ctb_luma_filter_alt_idx[xCtb>>CtbLog2SizeY][yCtb>>CtbLog2SizeY] is not present, it is inferred to be equal to zero.

### 3.8.2 Filter Shapes

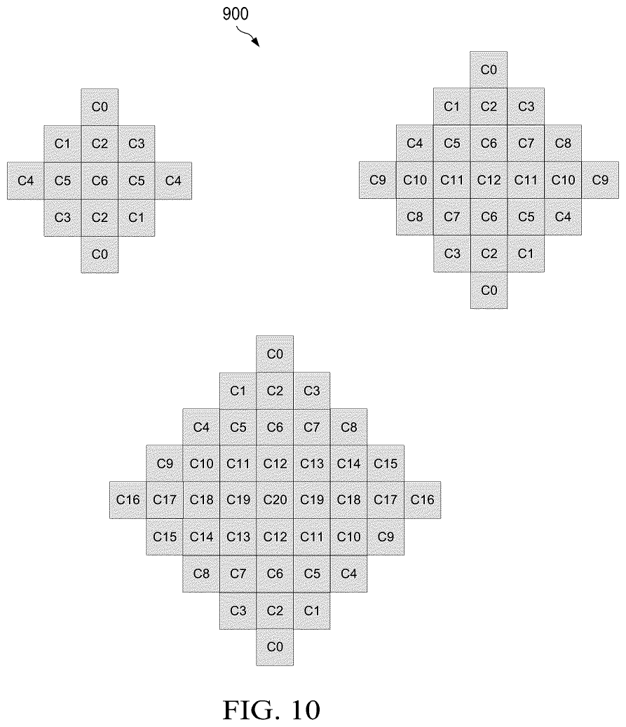

FIG. 10 illustrates an example of filter shapes for ALF. In the JEM, up to three diamond filter shapes (as shown in FIG. 10) can be selected for the luma component. An index is signaled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used. In VVC, the 7×7 diamond shape is always used for Luma while the 5×5 diamond shape is always used for Chroma.

### 3.8.3 Classification for ALF

Each 2×2 (or 4×4) block is categorized into one out of 25 classes. The classification index C is derived based on its directionality D and a quantized value of activity Â, as follows:

$$C = 5 D + Â .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i,j) indicates a reconstructed sample at coordinate (i,j). Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) ,$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) ,$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â. For both chroma components in a picture, no classification method is applied, i.e. a single set of ALF coefficients is applied for each chroma component.

### 3.8.4 Geometric Transformations of Filter Coefficients

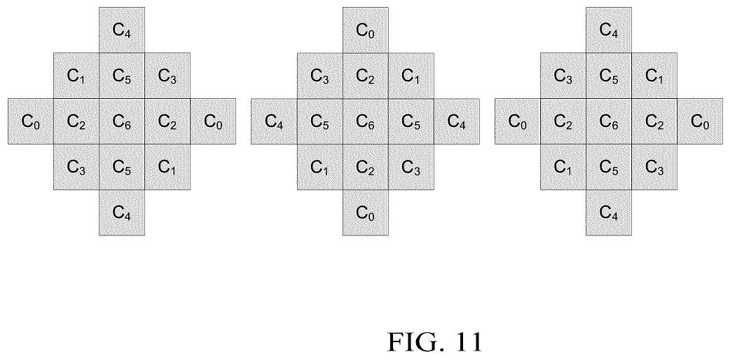

FIG. 11 illustrates an example of a relative coordinator for the 5×5 diamond filter support. Before filtering each 2×2 block, geometric transformations such as rotation or diagonal and vertical flipping are applied to the filter coefficients f(k,l), which is associated with the coordinate (k,l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) ,$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k,l≤K−1 are coefficients coordinates, such that location (0,0) is at the upper left corner and location (K−1,K−1) is at the lower right corner. The transformations are applied to the filter coefficients f(k,l) depending on gradient values calculated for that block. The relationship between the transformation and the four gradients of the four directions are summarized in Table 5. FIG. 11 shows the transformed coefficients for each position based on the 5×5 diamond.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

Table 5. Mapping of the gradient calculated for one block and the transformations.

### 3.8.5 Filtering Process

At decoder side, when ALF is enabled for a block, each sample R(i,j) within the block is filtered, resulting in sample value R′(i,j) as shown below, where L denotes filter length, f_{m,n} represents filter coefficient, and f(k,l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l )$$

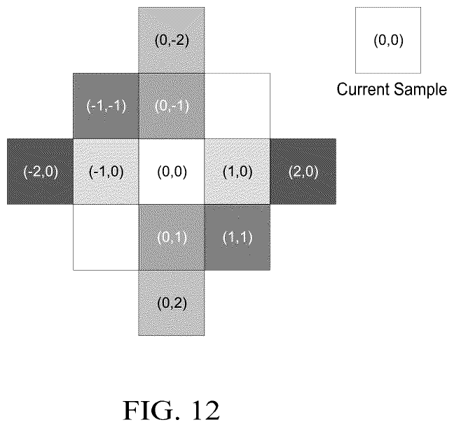

FIG. 12 shows an example of relative coordinates used for 5×5 diamond filter support supposing the current sample's coordinate (i, j) to be (0, 0). Samples in different coordinates filled with the same color are multiplied with the same filter coefficients.

### 3.8.6 Non-Linear Filtering Reformulation

Linear filtering can be reformulated, without coding efficiency impact, in the following expression:

$$O ( x , y ) = l ( x , y ) + {\sum }_{( i , j ) \neq ( 0 , 0 )} w ( i , j ) \cdot ( I ( x + i , y + j ) - I ( x , y ) )$$

where w(i,j) are the same filter coefficients.

VVC introduces the non-linearity to make ALF more efficient by using a simple clipping function to reduce the impact of neighbor sample values (I(x+i,y+j)) when they are too different with the current sample value (I(x,y)) being filtered. More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) )$$

where K(d,b)=min(b,max(−b,d)) is the clipping function, and k(i,j) are clipping parameters, which depends on the (i,j) filter coefficient. The encoder performs the optimization to find the best k(i,j).

The clipping parameters k(i,j) are specified for each ALF filter, one clipping value is signaled per filter coefficient. It means that up to 12 clipping values can be signaled in the bitstream per Luma filter and up to 6 clipping values for the Chroma filter. In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary. The 4 values have been selected by roughly equally splitting, in the logarithmic domain, the full range of the sample values (coded on 10 bits) for Luma, and the range from 4 to 1024 for Chroma. More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} ,$$

with M=2¹⁰ and N=4

Similarly, the Chroma tables of clipping values is obtained according to the following formula:

$${AlfClip}_{C} = \{ round ( A \cdot {( {( \frac{M}{A} )}^{\frac{1}{N -}} )}^{N - n} ) for n ∈ 1 … N ] \} ,$$

with M=2¹⁰, N=4 and A=4

### 3.9 Bilateral In-Loop Filter

### 3.9.1 Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{\frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 3.9.2 Bilateral Filter in Video Coding

The bilateral filter in video coding is a coding tool for the VVC [2]. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {w}_{A} + {w}_{B} + {w}_{L} + {w}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 4. Technical Problems Solved by Disclosed Technical Solutions

Example designs for adaptive loop filter (ALF) in video coding have the following problems.

In an example ALF design, only the spatial reconstruction samples after other filtering (such as deblocking filtering/SAO/BF) are used for filter training and filtering. However, there is other valuable information that can be potentially utilized, such as samples filtered/generated by one or more pre-defined filters.

In an example ALF design, only the spatial reconstruction samples after other filtering (such as deblocking filtering/SAO/BF) are used for filter training and filtering. However, there is other valuable information that can be potentially utilized, such as samples before DBF, SAO or other stages.

In an example ALF design, only the spatial reconstruction samples after other filtering (such as deblocking filtering/SAO/BF) are used for filter training and filtering. However, there is other valuable information that can be potentially utilized, such as prediction/residual samples and coded reference pictures.

### 5. A Listing of Solutions and Embodiments

To solve the above-described problems, methods as summarized below are disclosed. The embodiments should be considered as examples to explain the general concepts and should not be interpreted in a narrow way. Furthermore, these embodiments can be applied individually or combined in any manner.

It should be noted that the disclosed methods may be used as in-loop filters or post-processing.

In this disclosure, a video unit may refer to a sequence, a picture, a sub-picture, a slice, a CTU, a block, and/or a region. The video unit may comprise one color component or multiple color components.

In this disclosure, an ALF processing unit may refer to a sequence, a picture, a sub-picture, a slice, a CTU, a block, a region, or a sample. The ALF processing unit may comprise one color component or multiple color components.

In this disclosure, an extended tap may refer to a filtering tap not used by ALF in VVC.

### Example 1

In an example, at least one extended tap is used for an ALF filter to further enhance the efficiency of ALF.

### Example 2

In one example, at least one extended tap may be different from the spatial tap in an ALF filter which only utilize the information of the spatial neighbor samples (neighbor to the central sample to be filtered) of the targeting component.

In one example, the spatial neighbor samples may come from the reconstruction after DBF/SAO/BF. In one example, the spatial taps may only use spatial neighbor Luma samples to filter the central Luma sample inside one ALF filter. In one example, the spatial taps may only use spatial neighbor Chroma samples to filter the central Chroma sample inside one ALF filter.

### Example 3

In one example, at least one extended tap and at least one spatial tap may co-exist inside one ALF filter.

In one example, an ALF filter may include both spatial and extended taps. In one example, an ALF filter may include M (e.g., M>0) spatial tap/taps and N (e.g., N>0) extended tap/taps.

### Example 4

In one example, one or more extended taps of an ALF filter may use one or more input sources.

In one example, one or more extended taps of an ALF filter may use one input source.

For example, the input source may be based on one of the following: reconstruction before DBF, intermediate filtering result of a pre-defined filter, reconstruction before SAO/BF, prediction samples, residual samples, collocated samples, any modification of the above sources, and/or any combination or fusion (e.g., weighted sum) of at least two sources.

In one example, one or more extended taps of an ALF filter may use multiple input sources. For example, the multiple input sources may comprise more than one of the following: reconstruction before DBF, intermediate filtering result of a pre-defined filter, reconstruction before SAO/BF, prediction samples, residual samples, collocated samples, and/or any modification of the above sources.

The input source of an extended tap may also be used by other taps in ALF. The input source of an extended tap may not be used by other taps in ALF. The input source of an extended tap may be filtered prediction samples. The input source of an extended tap may be filtered residual samples. The input source of an extended tap may be weighted sum or filtering of multiple sources. The input source of an extended tap may be an output of a function of multiple sources. The input source of an extended tap may be derived based on samples in a different color component.

### Example 5

In one example, whether to and/or how to apply a filter with at least one extended tap may be performed in different ways for different color formats and/or different color components.

In one example, an ALF filter with at least one extended tap may be only applied to process Luma component. In one example, an ALF filter with at least one extended tap may be only applied to process one of the Chroma components (e.g., Cb or Cr component). In one example, an ALF filter with at least one extended tap may be applied to process all Chroma components. (e.g., Cb and Cr component). In one example, an ALF filter with at least one extended tap may be applied to filter Luma and Chroma components. (e.g., Y, Cb and Cr component).

### Example 6

In one example, the coefficient of an extended tap inside an ALF filter may correspond to one or more input samples.

In one example, the coefficient of an extended tap inside an ALF filter may be only corresponded to one input sample.

In one example, the coefficient of an extended tap inside an ALF filter may be corresponded to N input samples (e.g., N=2). In one example, the N input samples may be designed in a symmetrical way. In one example, the N input samples may be designed in an asymmetrical way. In one example, the coefficient of an extended tap inside an ALF filter may be shared by multiple inputs based on the geometrical information.

In one example, the multiple input samples may be located at symmetric positions.

### Example 7

In one example, an ALF filter with at least one extended tap may use shapes or sizes different from those used by ALF without extended taps (such as ALF in VVC).

In one example, an ALF filter may contain different shapes for the spatial and extended taps.

In one example, inside an ALF filter, the shape/size used for one or more spatial taps may be different from the shape/size used for one or more extended taps.

In one example, inside an ALF filter, the shape/size used for one or more spatial taps may be identical to the shape/size used for one or more extended taps.

In one example, inside an ALF filter with at least one extended tap, the filter shape used for one or more spatial taps may be as follows. In one example, the filter shape used for the spatial taps may be a diamond shape. In one example, the filter shape used for the spatial taps may be a square shape. In one example, the filter shape used for the spatial taps may be a cross shape. In one example, the filter shape used for the spatial taps may be a symmetrical shape. In one example, the filter shape used for the spatial taps may be an asymmetrical shape. In one example, the filter shape used for the spatial taps may be other designed shapes. In one example, the filter shape used for the spatial taps may be determined on the fly/signaled/derived.

In one example, inside an ALF filter with at least one extended tap, the filter shape used for one or more extended taps may be as follows. In one example, the filter shape used for the extended taps may be a diamond shape. In one example, the filter shape used for the extended taps may be a square shape. In one example, the filter shape used for the extended taps may be a cross shape. In one example, the filter shape used for the extended taps may be a symmetrical shape. In one example, the filter shape used for the extended taps may be an asymmetrical shape. In one example, the filter shape used for the extended taps may be other designed shapes. In one example, the filter shape used for the extended taps may be determined on the fly/signaled/derived.

In one example, an ALF filter that contains at least one spatial tap and at least one extended tap may be designed as follows.

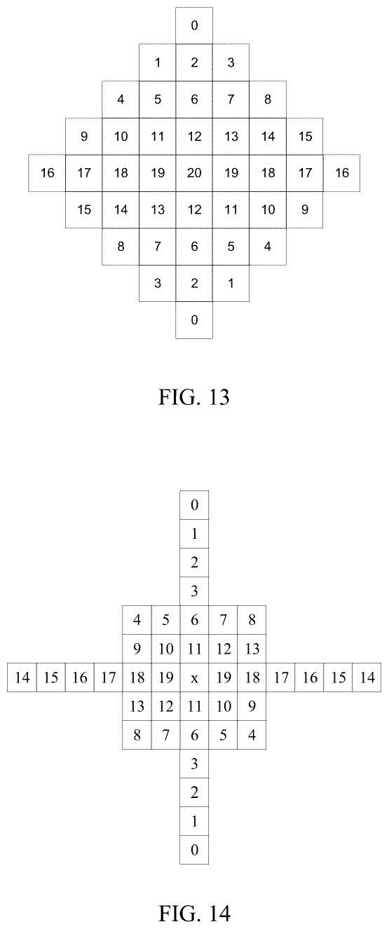

In one example, one or more spatial taps may be used for filtering (the spatial taps may be considered as using reconstruction before ALF as input). In one example, shape for the spatial taps may be designed as FIG. 13. FIG. 13 illustrates an example shape for at least one spatial tap. In one example, shape for the spatial taps may be designed as FIG. 14. FIG. 14 illustrates an example shape for at least one spatial tap.

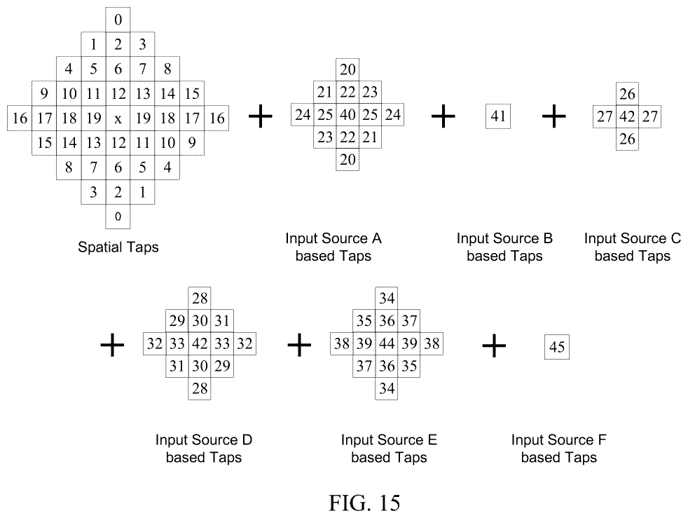

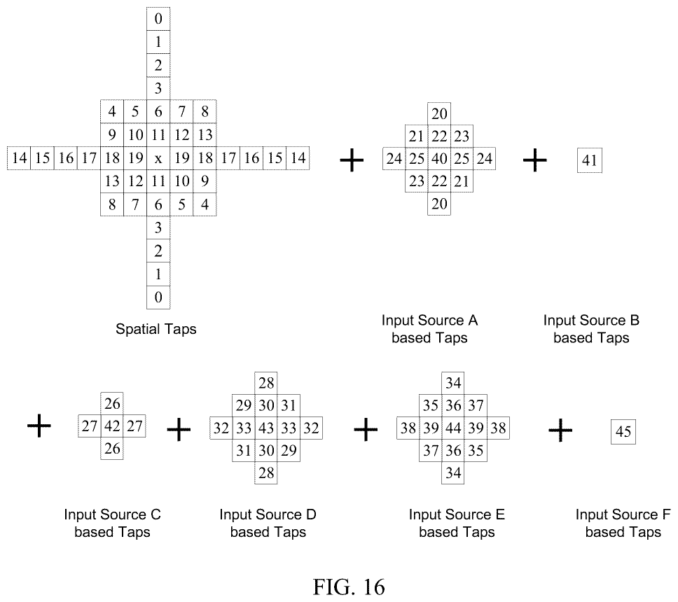

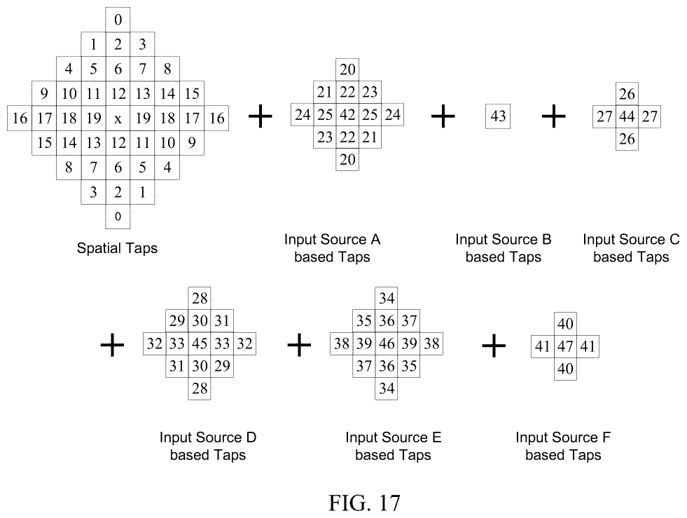

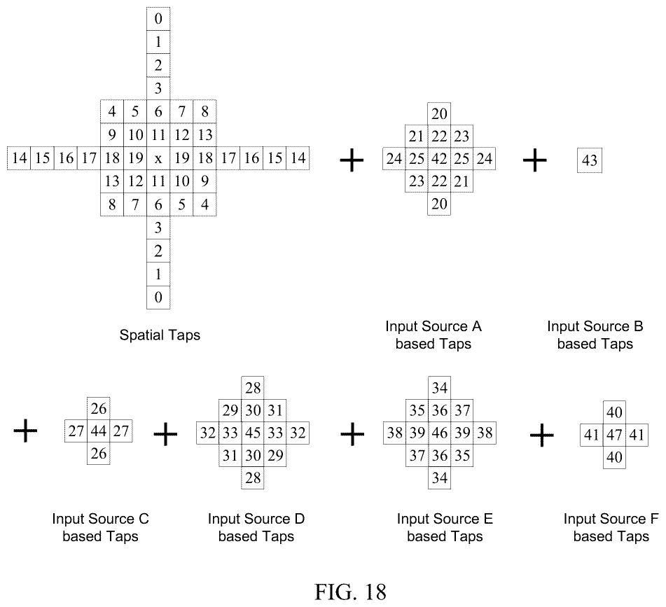

In one example, one or more extended taps may be applied for filtering. In one example, an ALF filter with one or more spatial taps and one or more extended taps may designed as follows. In one example, an ALF filter may be designed as FIG. 15. FIG. 15 illustrates an example ALF filter with spatial and extended taps. In one example, an ALF filter may be designed as FIG. 16. FIG. 16 illustrates an example ALF filter with spatial and extended taps. In one example, an ALF filter may be designed as FIG. 17. FIG. 17 illustrates an example ALF filter with spatial and extended taps. In one example, an ALF filter may be designed as FIG. 18. FIG. 18 illustrates an example ALF filter with spatial and extended taps.

In one example, the geometrical-information-based transportation may be applied. In one example, the geometrical information may be used. In one example, the gradient information may be used to generate the geometrical information. In one example, the texture direction may be considered as geometrical information. In one example, the texture direction may be horizontal. In one example, the texture direction may be vertical. In one example, the texture direction may be diagonal. In one example, the texture direction may be distributed along with an angle of N degree. (e.g., N=60, 120 or 150)

In one example, the transportation may be used. In one example, the vertical flipping of the coefficients/inputs may be considered as a way of transportation. In one example, the horizontal flipping of the coefficients/inputs may be considered as way of transportation. In one example, the N degree rotation of the coefficients/inputs may be considered as a way of transportation. (e.g., N=90 or 135). In one example, the combination of vertical/horizontal flipping and rotation may be considered as a way of transportation. (e.g., perform the flipping before/after the rotation).

In one example, the geometrical-information-based transportation may be applied to one or more spatial taps independently. In one example, the geometrical-information-based transportation may be applied to one or more extended taps independently. In one example, the geometrical-information-based transportation may be applied to one or more spatial taps and one or more extended taps jointly.

In one example, there may be one or more input sources to be used for one or more extended tap. In one example, the input source A/B/C/D/E shown in the FIG. 15/FIG. 16/FIG. 17/FIG. 18 may be different. In one example, In one example, the input source A/B/C/D/E shown in the FIG. 15/FIG. 16/FIG. 17/FIG. 18 may be identical. In one example, one possible input source for one or more extended taps may be based on samples before ALF. In one example, one possible input source for one or more extended taps may be based on samples before DBF. In one example, one possible input source for one or more extended taps may be based on reconstruction samples. In one example, one possible input source for one or more extended taps may be based on prediction samples of current frame. In one example, one possible input source for one or more extended taps may be based on residual samples of current frame. In one example, one possible input source for one or more extended taps may be based on samples from the coded reference picture.

In one example, one possible input source for one or more extended taps may be based on intermediate filtering results generated by reconstruction before ALF and offline-trained-filter of ALF. In one example, a specific offline-trained-filter set may be applied. In one example, the offline-trained-filter set indicator may be signaled/pre-defined/derived on-the-fly. In one example, a specific offline-trained-filter classifier may be applied. In one example, the offline-trained-filter classifier indicator may be signaled/pre-defined/derived on-the-fly.

In one example, one possible input source for one or more extended taps may be based on intermediate filtering results generated by reconstruction before DBF and offline-trained-filter of ALF. In one example, a specific offline-trained-filter set may be applied. In one example, the offline-trained-filter set indicator may be signaled/pre-defined/derived on-the-fly. In one example, a specific offline-trained-filter classifier may be applied. In one example, the offline-trained-filter classifier indicator may be signaled/pre-defined/derived on-the-fly.

In one example, the indicator for input source may be signaled in A PS/pre-defined/derived on-the-fly. In one example, the total number of extended taps inside an ALF filter may be derived based on the shape, filter length, and symmetrical constraint jointly.

### Example 8

In one example, the input samples of extended taps may be padded among picture/slice/tile/CTU boundaries.

In one example, the padding may be applied to any boundary during encoding/decoding process. In one example, the padding may be applied to a picture/sub-picture boundary. In one example, the padding may be applied to a slice/tile boundary. In one example, the padding may be applied to CTU/CTB boundary. In one example, the padding may be applied to CU/TU/PU boundary. In one example, the padding may be applied to a block boundary. In one example, the padding may be applied to a unit boundary. In one example, the padding may be applied to a virtual boundary. In one example, the padding may be applied to any other type of boundary.

In one example, different padding methods may be applied to a boundary. In one example, the extended padding may be applied. In one example, the mirrored padding may be applied. In one example, the duplicated padding may be applied. In one example, motion-compensation-based padding may be applied. In one example, other padding method may be applied.

In one example, samples outside a boundary may be used as input source for one or more ALF taps. For example, motion-compensated padded samples outside a picture boundary may be used. For example, a sample exceeds a virtual boundary may be used. For example, a sample in a refreshed region (e.g., may or may not exceed a virtual boundary) of a gradual decoding refresh (GDR) area may be used as input source for one or more ALF taps.

### Example 9

In one example, a first syntax element may be signaled to indicate whether a filter with at least one extended tap is enabled.

In one example, the first syntax element may be coded by arithmetic coding. In one example, the first syntax element may be coded with at least one context. The context may depend on coding information of the current block or neighbouring block. The context may depend on the filtering shape of at least one neighbouring block. In one example, the first syntax element may be coded with bypass coding. In one example, the first syntax element may be binarized by unary code, or truncated unary code, or fixed-length code, or exponential Golomb code, truncated exponential Golomb code, etc.

In one example, the first syntax element may be signaled conditionally. For example, the first syntax element may be signaled only if the extended taps are available.

The first syntax element may be coded in a predictive way. The first syntax element may be predicted by the on/off decision of extended taps of at least one neighbouring block.

In one example, the first syntax element may be signaled independently for different color components. In one example, the first syntax element may be signaled and shared for different color components. In one example, the first syntax element may be signaled for a first color component but not signaled for a second color component.

The syntax element may be signaled in SPS/PPS/picture header/slice header/APS/CTU/CU/etc.

### Example 10

In one example, a first syntax element may be signaled to indicate which/what input sources are used for the extended taps inside an ALF filter.

In one example, the first syntax element may be coded by arithmetic coding. In one example, the first syntax element may be coded with at least one context. The context may depend on coding information of the current block or neighbouring block. The context may depend on the filtering shape of at least one neighbouring block. In one example, the first syntax element may be coded with bypass coding.

In one example, the first syntax element may be binarized by unary code, or truncated unary code, or fixed-length code, or exponential Golomb code, truncated exponential Golomb code, etc.

In one example, the first syntax element may be signaled conditionally. For example, the first syntax element may be signaled only if the extended taps are available.

The first syntax element may be coded in a predictive way. The first syntax element may be predicted by the on/off decision of extended taps of at least one neighbouring block.

The first syntax element may be signaled independently for different color components. In one example, the first syntax element may be signaled and shared for different color components. In one example, the first syntax element may be signaled for a first color component but not signaled for a second color component.

The syntax element may be signaled in SPS/PPS/picture header/slice header/APS/CTU/CU/etc. In one example, the syntax element may be signaled in APS for a signaled ALF filter.

### Example 11

Coefficient of at least one extended tap inside an ALF filter may be signaled in a syntax element structure (such as an APS). In one example, the coefficients of extended taps may be contained in an APS. In one example, the clipping parameters of extended taps may be contained in an APS. In one example, the class merging results of extended taps may be contained in an APS. In one example, the coefficient of an extended tap may be coded in a predictive way. In one example, the coefficient of an extended tap may be coded by arithmetic coding with at least one context. In one example, the coefficient of an extended tap may be coded with bypass coding. In one example, the coefficient of an extended tap may be jointly coded with the coefficient of a spatial tap. In one example, other parameters of extended taps may be contained in an APS. In one example, the coefficient of an extended tap may be a predefined fixed value.

### Example 12

In one example, intermediate filtering result of at least one fixed or adaptive filter are used as an input for one or more extended taps.

### Example 13

In one example, the intermediate filtering result of offline-trained filter may be used as input for one or more extended taps. In one example, the intermediate filtering results may be generated by the reconstruction before ALF and the offline-trained-filters of ALF. In one example, the intermediate filtering results may be generated by the reconstruction before DBF and the offline-trained-filters of ALF.

### Example 14

In one example, the intermediate filtering result of online-trained ALF filter may be used as input for one or more extended taps.

### Example 15

In one example, the intermediate filtering results of other pre-defined filter may be used as input for one or more extended taps. In one example, the gauss filter may be applied. In one example, the bilateral filter may be applied. In one example, the guided filter may be applied. In one example, the median filter may be applied. In one example, the local median filter may be applied. In one example, the non-local median filter may be applied. In one example, a filter with low-pass property may be applied. In one example, a filter with high-pass property may be applied.

### Example 16

In one example, the intermediate filtering results of other online-trained filter may be used as input for one or more extended taps.

### Example 17

In one example, the input for intermediate filtering may be reconstruction samples at different coding stages. In one example, the reconstruction before/after adaptive loop filter (ALF) of current/reference frame may be used to generate the intermediate filtering results. In one example, the reconstruction before/after sample adaptive offset (SAO)/cross component SAO (CCSAO) of current/reference frame may be used to generate the intermediate filtering results. In one example, the reconstruction before/after bilateral filter (BIF) of current/reference frame may be used to generate the intermediate filtering results. In one example, the reconstruction before/after deblocking filter (DBF) of current/reference frame may be used to generate the intermediate filtering results. In one example, the reconstruction before/after any other stage of current/reference frame may be used to generate the intermediate filtering results.

### Example 18

In one example reconstruction samples before/after different coding stages of a current frame are used as input for one or more extended taps.

In one example, the reconstruction before/after DBF of current frame may be used as input for one or more extended taps. In one example, the reconstruction before/after SAO/CCSAO of current frame may be used as input for one or more extended taps. In one example, the reconstruction before/after BIF of current frame may be used as input for one or more extended taps. In one example, the reconstruction before/after other stages of current frame may be used as input for one or more extended taps.

### Example 19

In an example, the prediction/residual samples of current frame are used as input for one or more extended taps. In one example, the prediction samples of current frame may be used as input for one or more extended taps. In one example, the residual samples of current frame may be used as input for one or more extended taps.

### Example 20

In one example, samples inside one or more coded picture are used as an input source for one or more extended taps.

### Example 21

In one example, a previously coded frame may be a reference frame in a reference picture list (RPL) or reference picture set (RPS) associated with the block/the current slice/frame. In one example, the previously coded frame may be a short-term reference picture of the block/the current slice/frame. In one example, the previously coded frame may be long-term reference picture of the block/the current slice/frame.

### Example 22

In one example, the previously coded frame may NOT be a reference frame, but it is stored in the decoded picture buffer (DPB).

### Example 23

In one example, at least one indicator is signaled to indicate which previously coded frame(s) to use. In one example, one indicator is signaled to indicate which reference picture list to use. In one example, at least one indicator may be signaled to indicate a reference index. In one example, the indicator may be conditionally signaled, e.g., depending on how many reference pictures are included in the RPL/RPS. In one example, the indicator may be conditionally signaled, e.g., depending on how many previously decoded pictures are included in the DPB.

### Example 24

In one example, which frames to be utilized is determined on-the-fly. In one example, the extended taps may take information from one/multiple previously coded frames in DPB. In one example, the extended taps may take information from one/multiple reference frames in list 0. In one example, the extended taps may take information from one/multiple reference frames in list 1. In one example, the extended taps may take information from reference frames in both list 0 and list 1. In one example, the extended taps may take information from the reference frame closest (e.g., with smallest picture order count (POC) distance to current slice/frame) to the current frame.

In one example, the extended taps may take information from the reference frame with reference index equal to K (e.g., K=0) in a reference list. In one example, K may be pre-defined. In one example, K may be derived on-the-fly according to reference picture information. In one example, K may be signaled.

In one example, the extended taps may take information from the collocated frame.

In one example, which frame to be utilized may be determined by the decoded information. In one example, which frame to be utilized may be defined as the top N (e.g., N=1) most-frequently used reference pictures for samples within the current slice/frame. In one example, which frame to be utilized may be defined as the top N (e.g., N=1) most-frequently used reference pictures of each reference picture list, if available, for samples within the current slice/frame. In one example, which frame to be utilized may be defined as the pictures with top N (e.g., N=1) smallest POC distances/absolute POC distances relative to current picture.

### Example 25

In one example, whether to take information from previously coded frames may be dependent on decoded information (e.g., coding modes/statistics/characteristics) of at least one region of the to-be-filtered block. In one example, an encoder may signal to a decoder whether to take information from previously coded frames of at least one region of the to-be-filtered block.

In one example, whether to take information from previously coded frames may be dependent on the slice/picture type. In one example, it may be only applicable to inter-coded slices/pictures (e.g., P or B slices/pictures). In one example, whether to take information from previously coded frames may be dependent on availability of reference pictures.

In one example, whether to take information from previously coded frames may be dependent on the reference picture information or the picture information in the DPB. In one example, if the smallest POC distance (e.g., smallest POC distance between reference pictures/pictures in DPB and current picture) is greater than a threshold, it is disabled.

In one example, whether to take information from previously coded frames may be dependent on the temporal layer index and/or QP and/or dimensions of the picture. In one example, it may be applicable to blocks with a given temporal layer index (e.g., the highest temporal layer).

In one example, if the to-be-filtered block contains a portion of samples that are coded in non-inter mode, the extended taps may not use information from previously coded frames to filter the block. In one example, the non-inter mode may be defined as intra mode. In one example, the non-inter mode may be defined as a set of coding mode which includes but not limited of intra/IBC/Palette modes.

In one example, a distortion between current block and the matching block is calculated and used to decide whether to take information from previously coded frames to filter current block. In one example, the distortion between the collocated block in a previously coded frame and current block may be used to decide whether to take information from previously coded frames to filter current block. In one example, motion estimation may be first used to find a matching block from at least one previously coded frame. In one example, when the distortion is larger than a pre-defined threshold, information from previously coded frames may not be used.

### Example 26

In one example, the information contains two reference blocks and/or collocated blocks of current block, with one of them from the first reference frame in list-0 and the other from the first reference frame in list-1.

### Example 27

In one example, the coded reference pictures may be accessed during different coding stages. In one example, the coded reference pictures may be accessed during the prediction loop stage.

In one example, the coded reference pictures may be accessed during the loop filter stage. In one example, the coded reference pictures may be accessed before DBF/SAO/CCSAO/BF/ChromaBF/ALF/CCALF or any other loop-filter process. In one example, the coded reference pictures may be accessed during DBF/SAO/CCSAO/BF/ChromaBF/ALF/CCALF or any other loop-filter process. In one example, the coded reference pictures may be accessed after DBF/SAO/CCSAO/BF/ChromaBF/ALF/CCALF or any other loop-filter process.

In one example, the coded reference pictures may be accessed after the loop filter stage. In one example, the coded reference pictures may be accessed after loop filter stage by a motion compensation based padding method.

### Example 28

In one example, an ALF filter may comprise more than one sub-filter. For example, one sub-filter may be based on samples in reference pictures. For example, one sub-filter may be based on samples in the current picture. For example, one sub-filter may be based on samples neighboring (e.g., adjacent neighbor, and/or, non-adjacent neighbor) to the current sample. For example, one sub-filter may be based on samples collocated (e.g., in the current picture, and/or in the reference picture) to the current sample.

For example, one sub-filter may be based on at least one intermediate filtered sample generated from “another filter”. For example, the intermediate filtered sample may be generated by filtering a group of samples neighboring and/or collocated to the current sample. For example, the “another filter” may be pre-defined. For example, the “another filter” may be off-line trained. For example, the “another filter” may be on-line signaled. For example, the intermediate filtered sample may have the same location of the current sample. For example, the intermediate filtered sample may be neighboring (e.g., adjacent, non-adjacent, temporally collocated) to the current sample.

For example, one sub-filter may be based on reconstruction samples. For example, one sub-filter may be based on prediction samples. For example, one sub-filter may be based on residual samples. For example, one sub-filter may be based on samples before deblocking. For example, one sub-filter may be based on samples after deblocking. For example, one sub-filter may be based on samples before DBF/SAO/CCSAO/BF. For example, one sub-filter may be based on samples after DBF/SAO/CCSAO/BF.

For example, an ALF filter may be constructed by one or more sub-filters from the following: A sub-filter calculated based on spatial neighboring reconstruction samples after SAO, a sub-filter calculated based on spatial neighboring reconstruction samples before deblocking, a sub-filter calculated based on spatial neighboring reconstruction samples after deblocking, a sub-filter calculated based on spatial neighboring prediction samples, a sub-filter calculated based on spatial neighboring residual samples, a sub-filter calculated based on temporal samples in a reference picture, a sub-filter calculated based on one or more intermediate filtered sample, and/or combinations thereof.

For example, more than one sub-filter may be cascaded applied (e.g., without selective determination). For example, all sub-filters may be cascaded applied (e.g., without selective determination).

For example, at least one sub-filter may be conditionally/adaptively used. For example, it may be conditioned by a syntax element. For example, it may be conditioned by a pre-defined rule.

### Example 29

In one example, the disclosed methods may be used in post-processing and/or pre-processing.

### Example 30

In one example, the above-mentioned methods may be used jointly.

### Example 31

In one example, the above-mentioned methods may be used individually.

### Example 32

In one example, the described extended tap for ALF method may be applied to any in-loop filtering tools, pre-processing, or post-processing filtering method in video coding (including but not limited to ALF/CCALF or any other filtering method).

### Example 33

In one example, the extended tap method may be applied to an in-loop filtering method. In one example, the extended taps method may be applied to ALF. In one example, the extended taps method may be applied to CCALF. Alternatively, the extended taps method may be applied to other in-loop filtering methods.

### Example 34

In one example, the extended taps method may be applied to a pre-processing filtering method. In one example, the extended taps method may be applied to a post-processing filtering method.

### Example 35

In above examples, the video unit may refer to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.

### Example 36

Whether to and/or how to apply the disclosed methods above may be signaled in a bitstream.

In one example, they may be signaled at sequence level/group of pictures level/picture level/slice level/tile group level, such as in a sequence header, picture header, SPS, VPS, DPS, DCI, PPS, APS, slice header, and tile group header.

In one example, they may be signaled at PB, TB, CB, PU, TU, CU, VPDU, CTU, CTU row, slice, tile, sub-picture, other kinds of region contain more than one sample or pixel.

### Example 37

Whether to and/or how to apply the disclosed methods above may be dependent on coded information, such as block size, color format, single/dual tree partitioning, color component, slice/picture type.

### 6. References

[1] J. Strom, P. Wennersten, J. Enhorn, D. Liu, K. Andersson and R. Sjoberg, “Bilateral Loop Filter in Combination with SAO,” in proceeding of IEEE Picture Coding Symposium (PCS), November 2019.

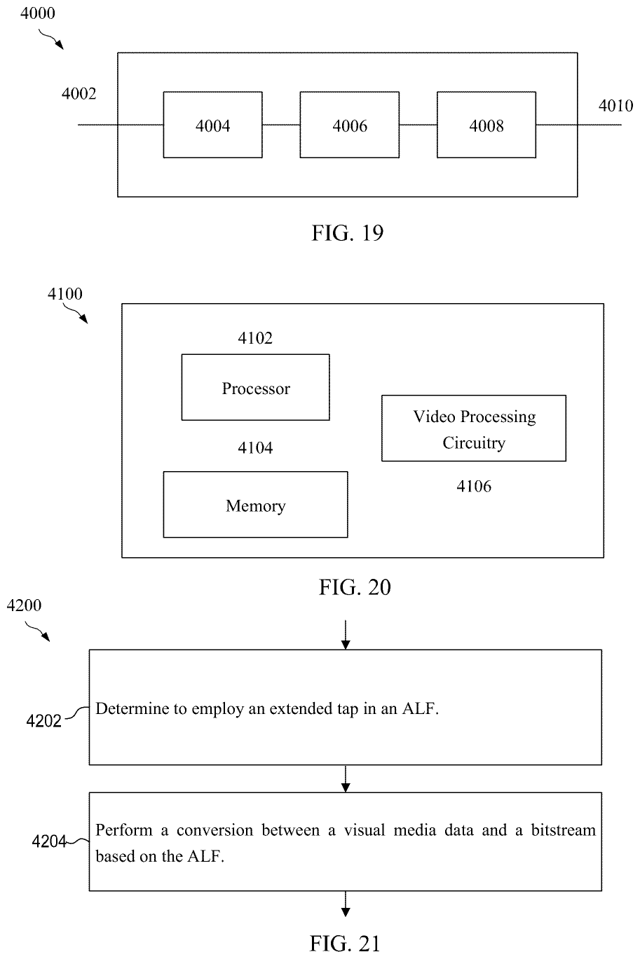

FIG. 19 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 20 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

FIG. 21 is a flowchart for an example method 4200 of video processing. The method 4200 includes determining to employ an extended tap in an adaptive loop filter (ALF) at step 4202. A conversion is performed between a visual media data and a bitstream based on the ALF at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

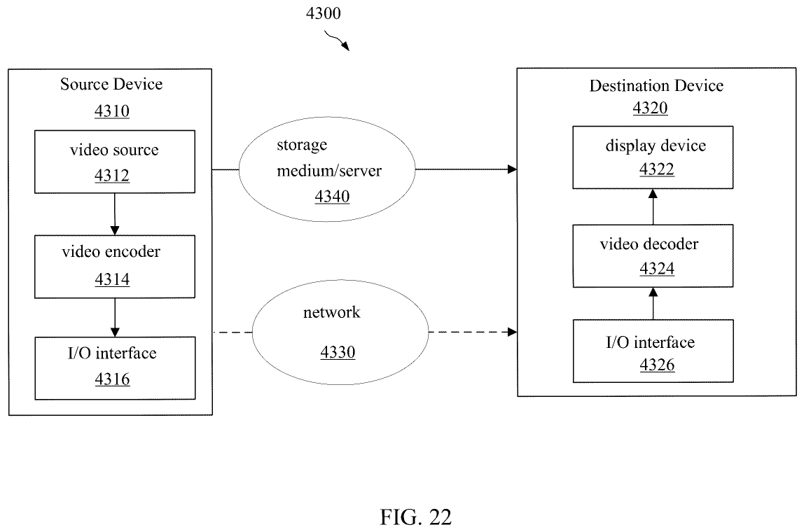

FIG. 22 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

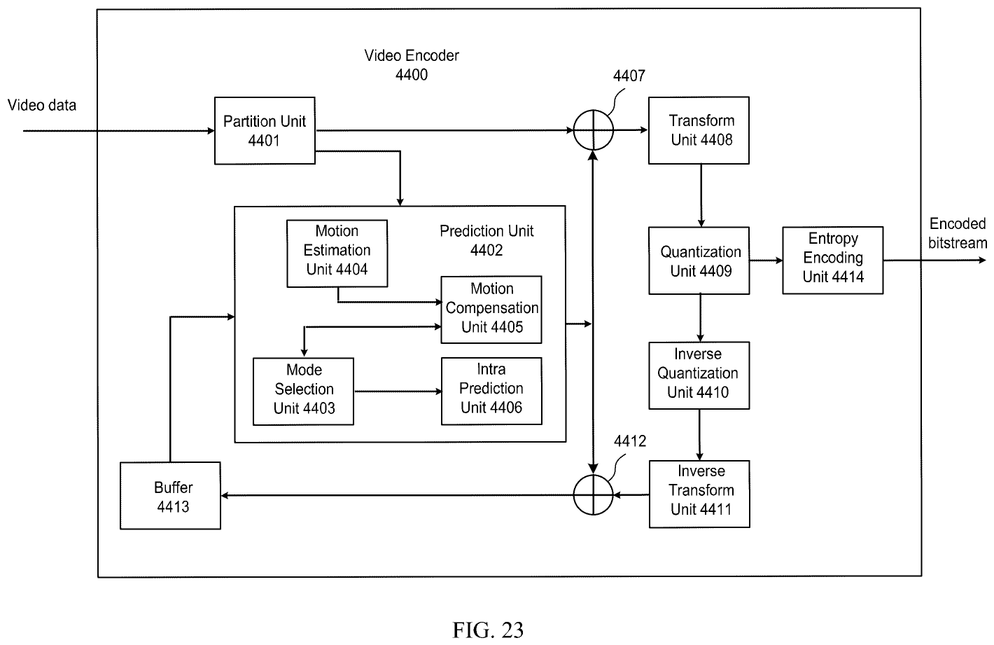

FIG. 23 is a block diagram illustrating an example of video encoder 4400, which may be video encoder 4314 in the system 4300 illustrated in FIG. 22. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

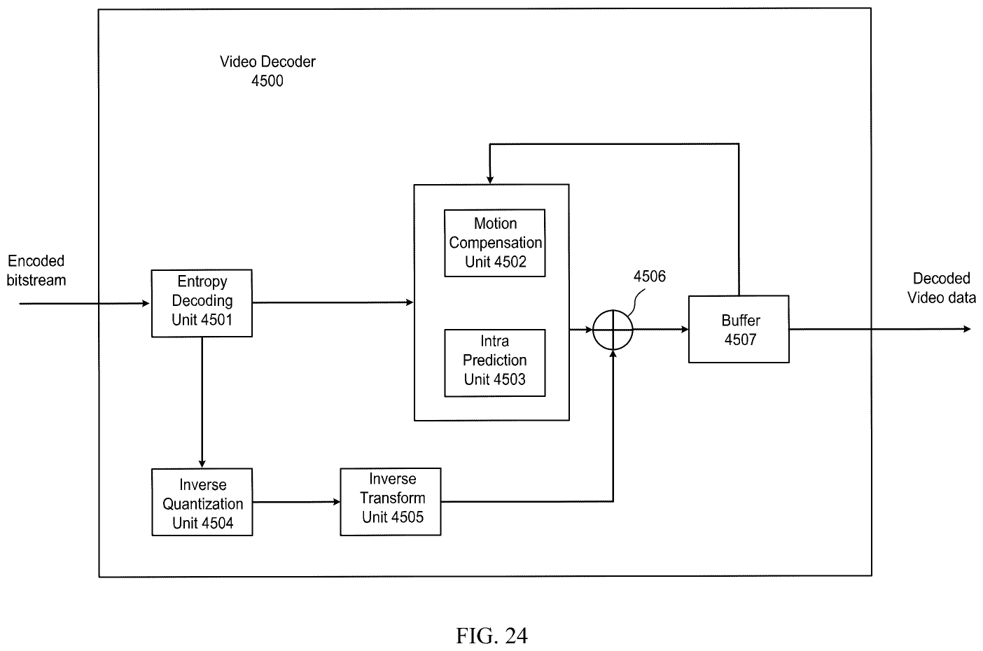

FIG. 24 is a block diagram illustrating an example of video decoder 4500 which may be video decoder 4324 in the system 4300 illustrated in FIG. 22. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

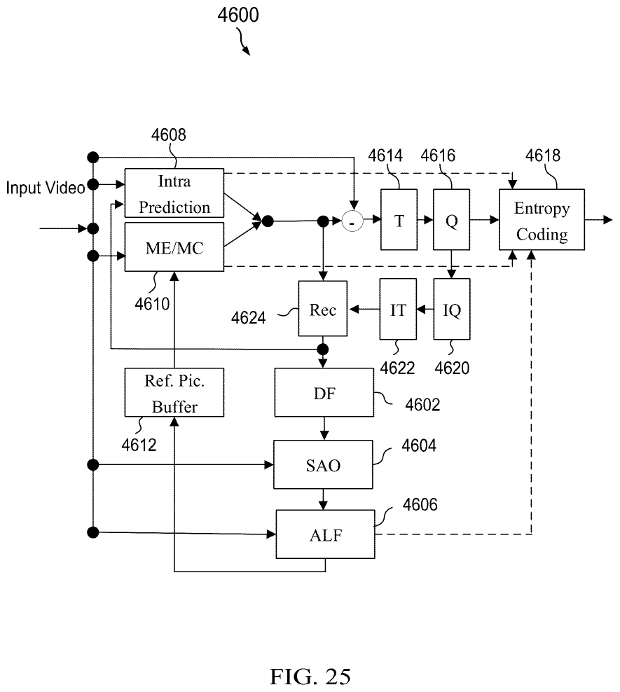

FIG. 25 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

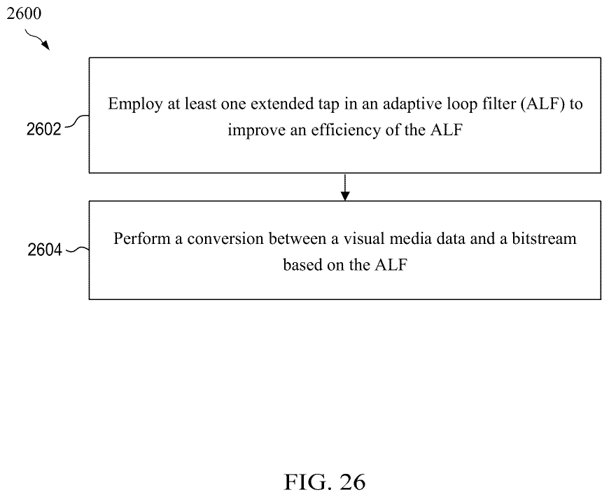

FIG. 26 is a method for processing video data in accordance with an embodiment of the disclosure. In block 2602, the method includes employing at least one extended tap in an adaptive loop filter (ALF) to improve an efficiency of the ALF. In block 2604, the method includes performing a conversion between a visual media data and a bitstream based on the ALF.

A listing of solutions preferred by some examples is provided next.

The following solutions show examples of techniques discussed herein.

1. A method for processing video data comprising: determining to employ an extended tap in an adaptive loop filter (ALF); and performing a conversion between a visual media data and a bitstream based on the ALF.

2. The method of solution 1, wherein the extended tap operates on spatial neighbor samples, and wherein the spatial neighbor samples are reconstructed and obtained after application of a deblocking filter (DBF), sample adaptive offset filter (SAO), bilateral filter (BF), or combinations thereof.

3. The method of any of solutions 1-2, wherein the spatial neighbor samples are luma samples and are used to filter a central luma sample inside the ALF or are chroma samples and are used to filter a central chroma sample inside the ALF.

4. The method of any of solutions 1-3, wherein the ALF incudes both one or more extended taps and one or more spatial taps.

5. The method of any of solutions 1-4, wherein the extended tap receives one or more input sources, and wherein the input sources include: a reconstruction before DBF, an intermediate filtering result of a pre-defined filter, a reconstruction before SAO, a reconstruction before BF, prediction samples, filtered prediction samples, residual samples, filtered residual samples, collocated samples, a weighted sum of multiple sources, a filtering of multiple sources, an output of a function applied to multiple sources, a cross component source, or any combination thereof.

6. The method of any of solutions 1-5 wherein the extended tap is applied to: only luma components, only one chroma component, only all chroma components, or all components.

7. The method of any of solutions 1-6, wherein the extended tap includes a coefficient, and wherein the coefficient is applied to: one input sample, a number (N) of input samples in a symmetrical pattern, N input samples in an asymmetrical pattern, or multiple input samples in a symmetrical pattern from multiple inputs based on geometrical information.

8. The method of any of solutions 1-7, wherein the ALF employs a filter shape, and wherein the filter shape includes a diamond shape, a square shape, a cross shape, a symmetrical shape, an asymmetrical shape, or combinations thereof.

9. The method of any of solutions 1-8, wherein the ALF filter contains at least of spatial tap and at least one extended tap.

10. The method of any of solutions 1-9, wherein geometrical-information-based transportation is applied to one or more spatial taps, one or more extended taps, or combinations thereof.

11. The method of any of solutions 1-10, wherein the extended tap receives one or more input sources, and wherein the input sources include: samples before ALF, samples before DBF, reconstruction samples, prediction samples, residual samples, samples from a coded reference picture, an intermediate filtering results generated by reconstruction before ALF and offline-trained-filter of ALF, an intermediate filtering results generated by reconstruction before DBF and offline-trained-filter of ALF, or combinations thereof.

12. The method of any of solutions 1-11, wherein an indicator indicates an input source for the extended tap, and wherein the indicator is signaled, predefined, or derived.

13. The method of any of solutions 1-12, wherein a total number of extended taps are derived based on filter shape, filter length, and symmetrical constraints.

14. The method of any of solutions 1-13, wherein input samples of extended taps are padded among picture, slice, tile, or coding tree unit (CTU) boundaries.

15. The method of any of solutions 1-14, wherein a syntax element is signaled to indicate whether a filter with at least one extended tap is enabled.

16. The method of any of solutions 1-15, wherein a syntax element is signaled to indicate input sources used for the extended tap inside the ALF filter.

17. The method of any of solutions 1-16, wherein a coefficient of the extended tap in the ALF is signaled in an adaptation parameter set (APS).

18. The method of any of solutions 1-17, wherein the extended tap receives an intermediate filtering result as input, and wherein the intermediate filtering result is obtained from: an offline-trained filter, an online-trained ALF, a gauss filter, a BF, a guided filter, a median filter, a filter with low-pass property, a filter with high-pass property, or combinations thereof.

19. The method of any of solutions 1-18, wherein the extended tap receives reconstruction samples as input, and wherein the reconstruction samples are obtained: after DBF, after SAO, after cross-component SAO (CCSAO), or combinations thereof.

20. The method of any of solutions 1-19, wherein the extended tap receives samples from a coded picture as input, and wherein the coded picture is: a reference frame from a reference picture list (RPL) or a frame in a decoded picture buffer.

21. The method of any of solutions 1-20, wherein the coded picture is determined based on: a signaled indicator, information from a reference frame, information from a collocated frame, decoded information, or combinations thereof.

22. The method of any of solutions 1-21, wherein a determination to take information from previously coded frames for use in the extended tap is dependent on: decoded information of at least one region of a to-be-filtered block, signaling, slice type, picture type, reference picture information, picture information in the decoded picture buffer, temporal layer index, quantization parameters, dimensions of a picture, prediction mode, a distortion between a current block and a matching block, a distortion between the current block and a collocated block, or combinations thereof.

23. The method of any of solutions 1-22, wherein the coded reference picture is accessed during a prediction loop stage, during a loop filter stage, after a loop filter stage, or combinations thereof.

24. The method of any of solutions 1-23, wherein the ALF comprises one or more sub-filters, and wherein the sub-filters are based on: samples in reference pictures, samples in a current picture, neighboring samples, collocated samples, intermediate filtered samples, reconstruction samples, prediction samples, residual samples, samples before deblocking, samples before DBF, samples before SAO, samples before CCSAO, samples before BF, samples after deblocking, samples after DBF, samples after SAO, samples after CCSAO, samples after BF, or combinations thereof.

25. The method of any of solutions 1-24, wherein the ALF comprises one or more sub-filters, and wherein the sub-filters are calculated based on: spatial neighboring reconstruction samples after SAO, spatial neighboring reconstruction samples before deblocking, spatial neighboring reconstruction samples after deblocking, spatial neighboring prediction samples, spatial neighboring residual samples, temporal samples in a reference picture, one or more intermediate filtered samples, or combinations thereof.

26. The method of any of solutions 1-25, wherein the ALF comprises one or more sub-filters, and wherein the sub-filters are: cascaded without selective determination, used adaptively, or combinations thereof.

27. An apparatus for processing video data comprising: a processor; and a non-transitory memory with instructions thereon, wherein the instructions upon execution by the processor, cause the processor to perform the method of any of solutions 1-26.

28. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-26.

29. A non-transitory computer-readable recording medium storing a bitstream of a video which is generated by a method performed by a video processing apparatus, wherein the method comprises: determining to employ an extended tap in an adaptive loop filter (ALF); and generating the bitstream based on the determining.

30. A method for storing bitstream of a video comprising: determining to employ an extended tap in an adaptive loop filter (ALF); generating the bitstream based on the determining; and storing the bitstream in a non-transitory computer-readable recording medium.

31. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
employing, during a conversion between a visual media data and a bitstream, at least one extended tap in an adaptive loop filter (ALF) to improve an efficiency of the ALF; and
performing the conversion based on the ALF,
wherein the at least one extended tap and at least one spatial tap co-exist in the ALF.

2. The method of claim 1, wherein the at least one spatial tap is different than the at least one extended tap, wherein the at least one spatial tap is configured to utilize information of spatial neighbor samples of a target component;
wherein the spatial neighbor samples neighbor a central sample to be filtered; and
wherein the spatial neighbor samples are reconstructed and obtained after application of a deblocking filter (DBF), a sample adaptive offset filter (SAO), or a bilateral filter (BF).

3. The method of claim 1, wherein an input source for the at least one extended tap of the ALF is based on at least one of: reconstruction before a deblocking filter (DBF), an intermediate filtering result of a pre-defined filter, or residual samples, and preferably, wherein the residual samples are filtered residual samples.

4. The method of claim 1, wherein the ALF with the at least one extended tap is only applied to process a luma component.

5. The method of claim 1, wherein a coefficient of the at least one extended tap of the ALF only corresponds to one input sample.

6. The method of claim 1, wherein a coefficient of the at least one extended tap of the ALF corresponds to N input samples, wherein N is a positive integer, and wherein the N input samples are designed in a symmetrical way.

7. The method of claim 1, wherein the ALF contains different shapes for the at least one spatial tap and the at least one extended tap inside the ALF,
wherein a filter shape used for the at least one spatial tap of the ALF with the at least one extended tap is a symmetrical shape which includes a diamond shape, or cross shape; and
wherein a filter shape used for the at least one extended tap of the ALF filter with the at least one extended tap is a symmetrical shape which includes a diamond shape, or cross shape.

8. The method of claim 7, wherein a shape for the at least one spatial tap inside the ALF is:

[symbol]

9. The method of claim 7, wherein a shape for the at least one spatial tap inside the ALF is:

[symbol]

10. The method of claim 1, wherein input samples of the at least one extended tap are padded among boundaries, and wherein the boundaries include: a picture boundary, a sub-picture boundary, a slice boundary, a tile boundary, a coding tree unit (CTU) boundary, a coding tree block (CTB) boundary, or a virtual boundary; and
wherein different padding methods are applied to the boundaries, and wherein the different padding methods include: extended padding, mirrored padding, or duplicated padding.

11. The method of claim 1, wherein a first syntax element is included in the bitstream to indicate whether a filter with the at least one extended tap is enabled;
wherein a second syntax element is signaled to indicate which or what input sources are used for the at least one extended tap inside the ALF; and
wherein the first syntax element and the second syntax element are binarized by unary code, truncated unary code, fixed-length code, exponential Golomb code, or truncated exponential Golomb code.

12. The method of claim 1, wherein one or more coefficients of the at least one extended tap inside the ALF are contained in an APS; or
wherein clipping parameters of the at least one extended tap are contained in the APS.

13. The method of claim 1, wherein an intermediate filtering result of an offline-trained filter is used as input for the at least one extended tap inside the ALF, and
wherein the intermediate filtering result is generated by reconstruction before the ALF and the offline-trained-filters of the ALF; or
wherein the intermediate filtering result is generated by reconstruction before a deblocking filter (DBF) and the offline-trained-filters of the ALF, or
wherein the intermediate filtering result is generated by a pre-defined filter, and preferably, wherein the pre-defined filter includes a gauss filter.

14. The method of claim 1, wherein residual samples of a current frame are used as input for the at least one extended tap inside the ALF.

15. The method of claim 1, wherein the ALF comprises more than one sub-filter,
wherein one of the more than one sub-filter is based on samples in reference pictures;
wherein one of the more than one sub-filter is based on samples in a current picture;
wherein one of the more than one sub-filter is based on neighbor samples that are neighboring to a current sample, wherein the neighbor samples are adjacent neighbor or non-adjacent neighbor samples to the current sample;
wherein one of the more than one sub-filter is based on reconstruction samples;
wherein one of the more than one sub-filter is based on prediction samples;
wherein one of the more than one sub-filter is based on residual samples; or
wherein one of the more than one sub-filter is based on samples before DBF or SAO or CCSAO or BF.

16. The method of claim 1, wherein the conversion includes encoding the visual media data into the bitstream.

17. The method of claim 1, wherein the conversion includes decoding the visual media data from the bitstream.

18. An apparatus for processing media data comprising:
one or more processors; and
a non-transitory memory with instructions thereon, wherein the instructions upon execution by the processor cause the apparatus to:
employ, during a conversion between a visual media data and a bitstream, at least one extended tap in an adaptive loop filter (ALF) to improve an efficiency of the ALF; and
perform the conversion based on the ALF,
wherein the at least one extended tap and at least one spatial tap co-exist in the ALF.

19. A non-transitory computer readable storage medium storing instructions that cause a processor to:
employ, during a conversion between a visual media data and a bitstream, at least one extended tap in an adaptive loop filter (ALF) to improve an efficiency of the ALF; and
perform the conversion based on the ALF,
wherein the at least one extended tap and at least one spatial tap co-exist in the ALF.

20. A non-transitory computer-readable recording medium storing a bitstream of a video which is generated by a method performed by a video processing apparatus, wherein the method comprises:
employing at least one extended tap in an adaptive loop filter (ALF) to improve an efficiency of the ALF; and
generating the bitstream based on the ALF,
wherein the at least one extended tap and at least one spatial tap co-exist in the ALF.
